(19) United States
(12) Patent Application Publication
(10) Pub. No.: US 2011/0246549 A1
(43) Pub. Date: Oct. 6, 2011

(54) ADAPTIVE DISTRIBUTION OF THE PROCESSING OF HIGHLY INTERACTIVE APPLICATIONS

(75) Inventors: Gary Shon Katzenberger, Fall City, WA (US); Vijay Mital, Kirkland, WA (US); Olivier Colle, Bellevue, WA (US); Brian C. Beckman, Newcastle, WA (US); Darryl Ellis Rubin, Duvall, WA (US)

(73) Assignee: Microsoft Corporation, Redmond, WA (US)

(21) Appl. No.: 12/752,961

(22) Filed: Apr. 1, 2010

(51) Int. Cl. G06F 15/16

(52) U.S. Cl. 709/201

(57) ABSTRACT

An application defined by expressions whose execution may be dynamically distributed over multiple devices. An application defined by expressions may include a number of expressions that provide a symbolic representation of computations to be performed. The application defined by expressions may have input variables and output variables and provide a solution for the output variables using the input variables and the expressions that define the application. In providing a solution for the output variables, an expression engine may determine dependencies for the expressions to be solved and distribute the solution of some of those expressions dynamically at runtime to other devices based on the capabilities of the devices, privacy and security concerns, communications bandwidth and latency, the resources available to devices, and commercial or cost implications of where the processing is done.

### BACKGROUND

Often, the most effective way to convey information to a human being is visually. Accordingly, millions of people work with a wide range of visual items in order to convey or receive information, and in order to collaborate. Such visual items might include, for example, concept sketches, engineering drawings, explosions of bills of materials, three-dimensional models depicting various structures such as buildings or molecular structures, training materials, illustrated installation instructions, planning diagrams, and so on.

More recently, these visual items are constructed electronically using, for example, Computer Aided Design (CAD) and solid modeling applications. Often these applications allow authors to attach data and constraints to the geometry. For instance, the application for constructing a bill of materials might allow for attributes such as part number and supplier to be associated with each part, the maximum angle between two components, or the like. An application that constructs an electronic version of an arena might have a tool for specifying a minimum clearance between seats, and so on.

Such applications have contributed enormously to the advancement of design and technology. However, any given application does have limits on the type of information that can be visually conveyed, how that information is visually conveyed, or the scope of data and behavior that can be attributed to the various visual representations. If the application is to be modified to go beyond these limits, a new application would typically be authored by a computer programmer which expands the capabilities of the application, or provides an entirely new application. Also, there are limits to how much a user (other than the actual author of the model) can manipulate the model to test various scenarios.

### SUMMARY

Hiring computer programmers to create applications may be expensive, and it may be more cost effective to employ tools for creating applications that can be used by non-programmers. Existing tools for nonprogrammers to create applications include spreadsheets and document-authoring environments. One disadvantage of existing tools is that they may not allow the people using the tools to create applications that may be efficiently distributed over multiple devices. With existing tools, some computations may be distributed over different devices, but the user creating the application may need to specify in advance which portions of the application will be executed on different devices.

Applications defined by expressions may have advantages over other types of applications. Applicants have recognized and appreciated that an application defined by expressions may be created by non-computer-programmers, and thus it may be more cost-effective to develop and maintain an application defined by expressions than other types of applications.

Applicants have further appreciated that the solution of an application defined by expressions may be distributed over multiple devices to provide an improved experience for the user. In an application defined by expressions, an expression engine may determine that the solution of some expressions may be dependent on the solution of other expressions, and that the solution of some expressions may be performed on other devices. For example, where a user's device has low processing power but a fast network connection, a user may have an improved experience where computations are performed on a server rather than on the user's device. In some embodiments, expressions that use data private to a user may be solved on the user's device so that other devices do not have access to the user's private data.

Applicants have also appreciated that distribution of the solution of expressions in an application defined by expressions may be determined dynamically at runtime. An expression engine may consider capabilities of other devices and the resources available to them at the time expressions are being solved and determine how to distribute the solution of expressions to other devices at runtime to provide an improved experience for the user.

In embodiments described herein, an expression engine may be present on several devices, such as mobile phones, personal computers and servers. The expression engine on each device may contain an application defined by expressions. When a user uses an application, the expression engine may determine dependencies between the expressions to be solved, and distribute the solution of the expressions dynamically at runtime to other devices based on the capabilities of the devices and the resources available to them.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an environment in which the principles of the present invention may be employed including a data-driven composition framework that constructs a view composition that depends on input data;

FIG. 2 illustrates a pipeline environment that represents one example of the environment of FIG. 1;

FIG. 3 schematically illustrates an embodiment of the data portion of the pipeline of FIG. 2;

FIG. 4 schematically illustrates an embodiment of the analytics portion of the pipeline of FIG. 2;

FIG. 5 schematically illustrates an embodiment of the view portion of the pipeline of FIG. 2;

FIG. 6 illustrates a rendering of a view composition that may be constructed by the pipeline of FIG. 2;

FIG. 7 illustrates a flowchart of a method for generating a view composition using the pipeline environment of FIG. 2;

FIG. 8 illustrates a flowchart of a method for regenerating a view composition in response to user interaction with the view composition using the pipeline environment of FIG. 2;

FIG. 9 schematically illustrates the solver of the analytics portion of FIG. 4 in further detail including a collection of specialized solvers;

FIG. 10 illustrates a flowchart of the solver of FIG. 9 solving for unknown model parameters by coordinating the actions of a collection of specialized solvers;

FIG. 11 illustrates a rendering of an integrated view composition that extends the example of FIG. 6;

FIG. 12 illustrates a visualization of a shelf layout and represents just one of countless applications that the principles described herein may apply to;

FIG. 13 illustrates a visualization of an urban plan that the principles described herein may also apply to;

FIG. 14 illustrates a conventional visualization comparing children's education, that the principles of the present invention may apply to thereby creating a more dynamic learning environment;

FIG. 15 illustrates a conventional visualization comparing population density, that the principles of the present invention may apply to thereby creating a more dynamic learning environment;

FIG. 16 illustrates a computing system that represents an environment in which the composition framework of FIG. 1 (or portions thereof) may be implemented;

FIG. 17 illustrates an exemplary user interface from which a user may invoke an application defined by expressions;

FIG. 18 illustrates an exemplary user interface for an application defined by expressions;

FIG. 19 is a flowchart of an exemplary process for selecting a device to execute an expression; and

FIG. 20 illustrates an exemplary environment in which an application defined by expressions may be executed.

### DETAILED DESCRIPTION

Applicants have appreciated that developing applications may be more flexible and more cost effective where applications can be developed by a non-programmer. For example, developing an application in computer programming language, such as C++, may require a team of highly-paid computer programmers. By contrast, if tools may be provided that allow a person who is not a computer programmer to develop an application, that application may be developed at lower cost.

Applicants have also appreciated that applications may provide an improved experience for a user where the execution of the application may be distributed over more than one device. How well a particular application may run on a particular device may depend on the capabilities of the device and the resources available to the device. For example, how well an application may run on a device may depend on one or more of the following factors: the processing power of a device, the amount of memory or storage on a device, the user interface of a device, the speed of the network to which the device is attached, a latency toleration for a user, or the security and privacy of data used by an application.

For example, where a user is executing an application on his or her personal computer, the application may run more efficiently if part of that application may run on a server computer. The server computer may be able to execute portions of the application more efficiently than the user's computer or the server computer may have access to data that is not available to the user's computer.

Applicants have also appreciated that highly interactive applications may benefit from having the execution of the application distributed over more than one device. A highly interactive application may involve frequent input from a user. Where each input from the user may involve an expensive operation, such as the retrieval of data from a server, the performance of the application may be decreased. For a highly interactive application, the performance of the application may be improved if an expensive call to a server can be performed once in response to a first input from the user, and later inputs from the user may involve less expensive operations to be performed on the device using the data that has already been retrieved from the server.

Applicants have further appreciated that distribution of the execution of an application over different devices may be determined dynamically at the time of execution. For example, in executing an application on a particular device, it may generally be the case that the device is connected to a high-speed network, and thus capable of sending or receiving large amounts of data. In certain situations, however, the device may have a poor network connection or may not have a network connection at all, thus changing how the application may be efficiently executed. In some embodiments, the cost of using a network may be considered. For example, a mobile phone with a wi-fi connection may have access to inexpensive data transfer while a mobile phone with only a cellular connection may incur a significant expense to transfer data.

Applicants have appreciated that applications that are defined by a set of expressions may have advantages over other types of applications. An expression is a symbolic representation of a computation to be performed, which may include operators and operands. The operators of an expression may include any operators known to one of skill in the art (such as the common mathematical operators of addition, subtraction, multiplication, and division), any functions known to one of skill in the art, and functions defined by a user. The operands of an expression may include data (such as numbers or strings), hierarchical data (such as records, tuples, and sequences), symbols that represent data, and other expressions. An expression may thus be recursive in that an expression may be defined by other expressions.

A symbol may represent any type of data used in common programming languages or known to one of skill in the art. For example, a symbol may represent an integer, a rational number, a string, a Boolean, a sequence of data (potentially infinite), a tuple, or a record. In some embodiments, a symbol may also represent irrational numbers, while in other embodiments, symbols may not be able to represent irrational numbers.

For example, an expression may take the form of a symbolic representation of an algebraic expression, such at x²+2xy+y², where x and y may be symbols that represent data or other expressions. An expression may take the form of an equation, such as E=mc², where E, m, and c may by symbols representing data or other expressions. An expression may take the form of a function definition, such as ƒ(x)=x²−1, where ƒ is a symbol representing the function, x is a symbol representing an operand or argument of the function, and x²−1 is an expression that defines the function. An expression may also take the form of a function invocation, such as ƒ(3), which indicates that the function ƒ is to be invoked with an argument of 3.

Expressions may be solved by an expression engine to produce a result. For example, where the symbol x (itself an expression) represents the number 3 and the symbol y (also an expression) represents the number 2, the expression x²+2xy+y² may be solved by replacing the symbols with the values they represent, e.g., 2²+2×2×3+3², and then applying the operators to the operands to solve the entire expression as 25. In another example, where m is a symbol representing the number 2 and c is a symbol representing the number 3, the expression E, defined above, may be solved by replacing E with its definition, e.g., mc², replacing the symbols m and c with the values they represent, e.g., 2×3², and applying the operators to the operands to solve the expression as 18.

In evaluating an expression, the expression engine may apply the operators to the operands to the extent that the operators and operands are defined and to the extent that expression engine knows how to apply the operators to the operands. For example, where the symbol x represents the number 3 and the symbol y is not defined, the expression x²+2xy+y² may be solved by replacing the known symbols with the values they represent, e.g., 2²+2×2×y+y², and then applying the operators to the operands to solve the entire expression as 4+4y+y². Where the symbol x represents the number 3 and the symbol y represents the string “hello”, the expression x²+2xy+y² may be solved as 4+4×hello+hello², since the expression engine may not know how to perform arithmetic operations on the string “hello.”

In some embodiments, expressions may be declarative. A declarative expression may indicate a computation to be performed without specifying how to compute it. A declarative expression may be contrasted with an imperative expression, which may provide an algorithm for a desired result.

In some embodiments, expressions may be immutable. An expression is immutable if it cannot be changed. For example, once a definition is given, such as E=mc², the expression E cannot later be given a different definition. One advantage of immutability, is that applications defined by immutable expressions may be side-effect free in that the functionality of the application may not be able to be altered by users of the application. Where expressions are being solved in a distributed execution environment, immutability may be advantageous in that devices may be able to rely on an expression having the same value throughout the lifetime of the expression. Immutability of expressions may make it easier for independent parts of an application to execute in parallel, may reduce costs, and may improve efficiency.

An application may be defined by a set of expressions. An application defined by expressions may have input variables and output variables and the relationship between the input variables and the output variables may be defined by the set of expressions that defines the application. The determination of which variables are input variables and which variables are output variables may be determined by the user. In solving for the output variables, the expression engine may produce data (e.g., a number or a string) or may produce an expression of the input variables.

An application defined by expressions may be developed by a person who is not a computer programmer. In some embodiments, the required skill level for a person to develop an application defined by expressions may be similar to the skill level required to use office applications, such as Microsoft EXCEL®. A tool may also be provided to a user to assist the user in creating an application defined by expressions. For example, a tool to assist a user in creating an application defined by expressions may include a visual composition environment.

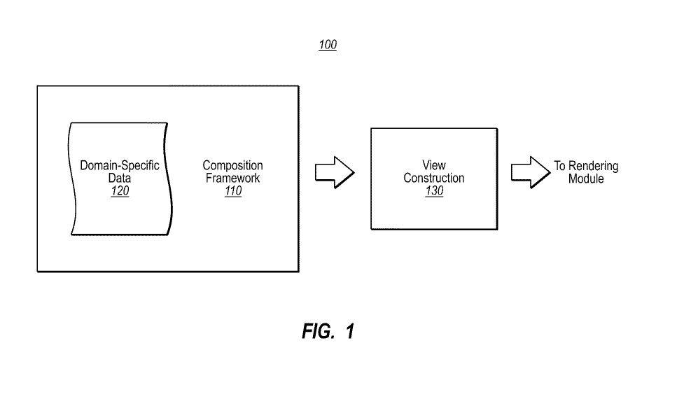

FIG. 1 illustrates a visual composition environment 100 that may be used to construct an interactive visual composition for an application defined by expressions. The construction of the interactive visual composition may be performed using data-driven analytics and visualization of the analytical results. The environment 100 includes a composition framework 110 that performs logic that is performed independently of the problem domain of the view composition 130. For instance, the same composition framework 110 may be used to compose interactive view compositions for city plans, molecular models, grocery shelf layouts, machine performance or assembly analysis, or other domain-specific renderings.

The composition framework 110 may use domain-specific data 120, however, to construct the actual visual composition 130 that is specific to the domain. Accordingly, the same composition framework 110 may be used to construct view compositions for any number of different domains by changing the domain-specific data 120, rather than having to recode the composition framework 110 itself. Thus, the composition framework 110 of environment 100 may apply to a potentially unlimited number of problem domains, or at least to a wide variety of problem domains, by altering data, rather than recoding and recompiling. The view composition 130 may then be supplied as instructions to an appropriate 2-D or 3-D rendering module. The architecture described herein also allows for convenient incorporation of pre-existing view composition models as building blocks to new view composition models. In one embodiment, multiple view compositions may be included in an integrated view composition to allow for easy comparison between two possible solutions to a model.

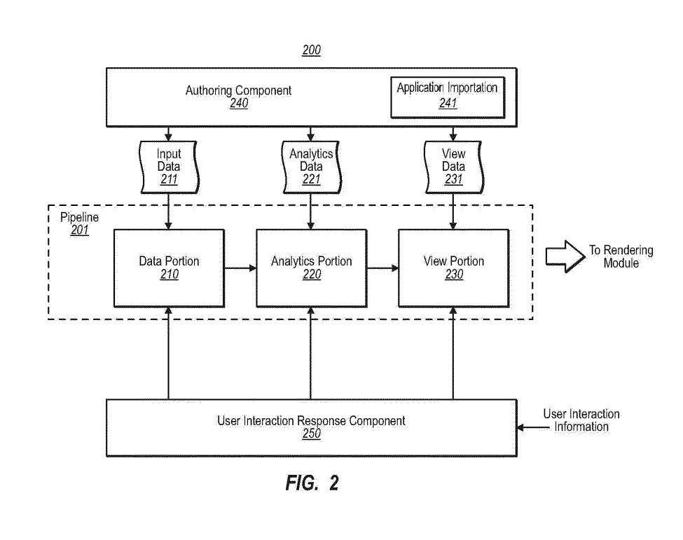

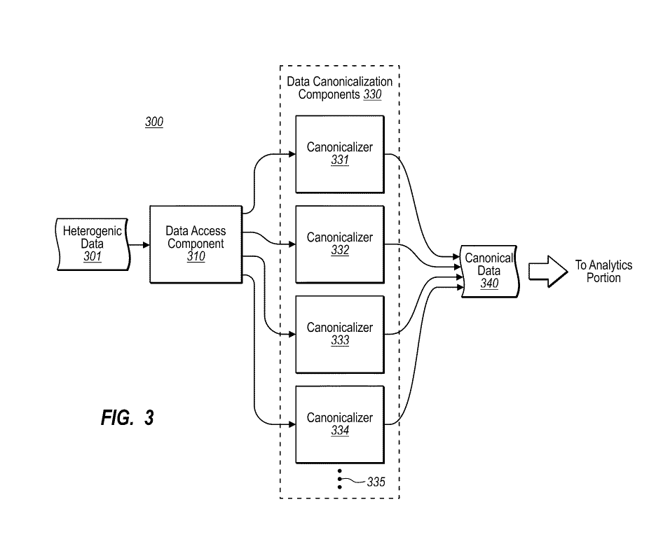

FIG. 2 illustrates an example architecture of the composition framework 110 in the form of a pipeline environment 200. The pipeline environment 200 includes, amongst other things, the pipeline 201 itself. The pipeline 201 includes a data portion 210, an analytics portion 220, and a view portion 230, which will each be described in detail with respect to subsequent FIG. 3 through 5, respectively, and the accompanying description. For now, at a general level, the data portion 210 of the pipeline 201 may accept a variety of different types of data and presents that data in a canonical form to the analytics portion 220 of the pipeline 201. The analytics portion 220 binds the data to various application parameters, and solves for the unknowns in the application parameters using application analytics. The various parameter values are then provided to the view portion 230, which constructs the composite view using those values of the application parameters.

The pipeline environment 200 also includes an authoring component 240 that allows an author or other user of the pipeline 201 to formulate and/or select data to provide to the pipeline 201. For instance, the authoring component 240 may be used to supply data to each of data portion 210 (represented by input data 211), analytics portion 220 (represented by analytics data 221), and view portion 230 (represented by view data 231). The various data 211, 221 and 231 represent an example of the domain-specific data 120 of FIG. 1, and will be described in much further detail hereinafter. The authoring component 240 supports the providing of a wide variety of data including for example, data schemas, actual data to be used by the application, the location or range of possible locations of data that is to be brought in from external sources, visual (graphical or animation) objects, user interface interactions that can be performed on a visual, modeling statements (e.g., views, equations, constraints), bindings, and so forth. In one embodiment, the authoring component is but one portion of the functionality provided by an overall manager component (not shown in FIG. 2, but represented by the composition framework 110 of FIG. 1). The manager is an overall director that controls and sequences the operation of all the other components (such as data connectors, solvers, viewers, and so forth) in response to events (such as user interaction events, external data events, and events from any of the other components such as the solvers, the operating system, and so forth).

Traditionally, the lifecycle of an interactive view-composition application involves two key times: authoring time, and use time. At authoring time, the functionality of the interactive view composition application is coded by a programmer to provide an interactive view composition that is specific to the desired domain. For instance, the author of an interior-design application (e.g., typically, a computer programmer) might code an application that permits a user to perform a finite set of actions specific to interior designing.

At use time, a user (e.g., perhaps a home owner or a professional interior designer) might then use the application to perform any one or more of the set of finite actions that are hard-coded into the application. In the interior design application example, the user might specify the dimensions of a virtual room being displayed, add furniture and other interior design components to the room, perhaps rotate the view to get various angles on the room, set the color of each item, and so forth. However, unless the user is a programmer who does not mind reverse-engineering and modifying the interior design application, the user is limited to the finite set of actions that were enabled by the application author. For example, unless offered by the application, the user would not be able to use the application to automatically figure out which window placement would minimize ambient noise, how the room layout performs according to Feng Shui rules, or minimize solar heat contribution.

However, in the pipeline environment 200 of FIG. 2, the authoring component 240 is used to provide data to an existing pipeline 201, where it is the data that drives the entire process from defining the input data, to defining the analytical model, to defining how the results of the analytics are visualized in the view composition. Accordingly, one need not perform any coding in order to adapt the pipeline 201 to any one of a wide variety of domains and problems. Only the data provided to the pipeline 201 is what is to change in order to apply the pipeline 201 to visualize a different view composition either from a different problem domain altogether, or to perhaps adjust the problem-solving for an existing domain. Further, since the data can be changed at use time (i.e., run time), as well as at author time, the application can be modified and/or extended at runtime. Thus, there is less, if any, distinction between authoring an application and running the application. Because all authoring involves editing data items and because the software runs all of its behavior from data, every change to data immediately affects behavior without the need for recoding and recompilation.

The pipeline environment 200 also includes a user-interaction response module 250 that detects when a user has interacted with the displayed view composition, and then determines what to do in response. For example, some types of interactions might require no change in the data provided to the pipeline 201 and thus require no change to the view composition. Other types of interactions may change one or more of the data 211, 221, or 231. In that case, this new or modified data may cause new input data to be provided to the data portion 210, might require a reanalysis of the input data by the analytics portion 220, and/or might require a re-visualization of the view composition by the view portion 230.

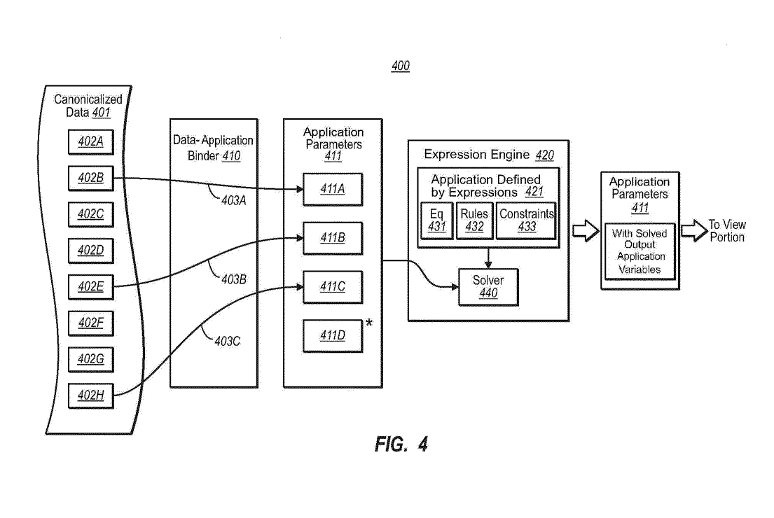

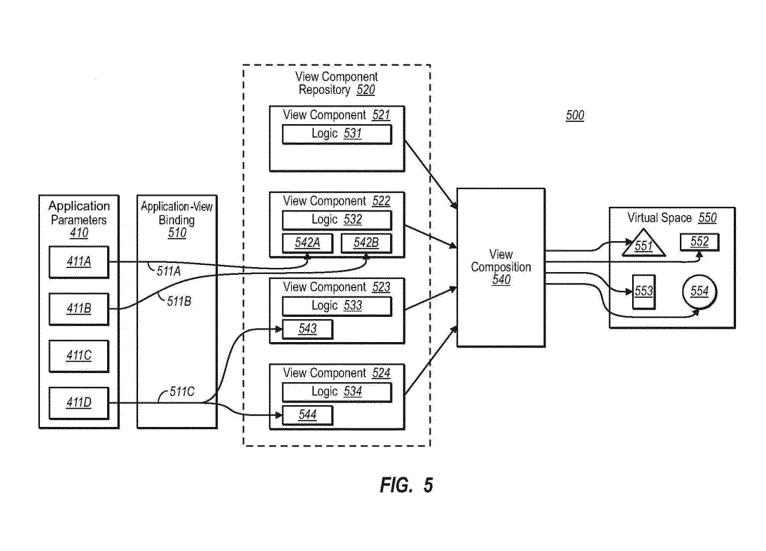

Accordingly, the pipeline 201 may be used to extend data-driven analytical visualizations to perhaps an unlimited number of problem domains, or at least to a wide variety of problem domains. Furthermore, one need not be a programmer to alter the view composition to address a wide variety of problems. Each of the data portion 210, the analytics portion 220 and the view portion 230 of the pipeline 201 will now be described with respect to respective data portion 300 of FIG. 3, the analytics portion 400 of FIG. 4, and the view portion 500 of FIG. 5, in that order. As will be apparent from FIG. 3 through 5, the pipeline 201 may be constructed as a series of transformation component where they each 1) receive some appropriate input data, 2) perform some action in response to that input data (such as performing a transformation on the input data), and 3) output data which then serves as input data to the next transformation component.

The pipeline 201 may be implemented on the client, on the server, or may even be distributed amongst the client and the server without restriction. For instance, the pipeline 201 might be implemented on the server and provide rendering instructions as output. A browser at the client-side may then just render according to the rendering instructions received from the server. At the other end of the spectrum, the pipeline 201 may be contained on the client with authoring and/or use performed at the client. Even if the pipeline 201 was entirely at the client, the pipeline 201 might still search data sources external to the client for appropriate information (e.g., models, connectors, canonicalizers, schemas, and others). There are also embodiments that provide a hybrid of these two approaches. For example, in one such hybrid approach, the application is hosted on a server but web browser modules are dynamically loaded on the client so that some of the application's interaction and viewing logic is made to run on the client (thus allowing richer and faster interactions and views).

FIG. 3 illustrates just one of many possible embodiments of a data portion 300 of the pipeline 201 of FIG. 2. One of the functions of the data portion 300 is to provide data in a canonical format that is consistent with schemas understood by the analytics portion 400 of the pipeline discussed with respect to FIG. 4. The data portion includes a data access component 310 that accesses the heterogenic data 301. The input data 301 may be “heterogenic” in the sense that the data may (but need not) be presented to the data access component 310 in a canonical form. In fact, the data portion 300 is structured such that the heterogenic data could be of a wide variety of formats. Examples of different kinds of domain data that can be accessed and operated on by applications include text and XML documents, tables, lists, hierarchies (trees), SQL database query results, BI (business intelligence) cube query results, graphical information such as 2D drawings and 3D visual models in various formats, and combinations thereof (i.e, a composite). Further, the kind of data that can be accessed can be extended declaratively, by providing a definition (e.g., a schema) for the data to be accessed. Accordingly, the data portion 300 permits a wide variety of heterogenic input into the application, and also supports runtime, declarative extension of accessible data types.

In one embodiment, the data access portion 300 includes a number of connectors for obtaining data from a number of different data sources. Since one of the primary functions of the connector is to place corresponding data into canonical form, such connectors will often be referred to hereinafter and in the drawings as “canonicalizers”. Each canonicalizer might have an understanding of the specific Application Program Interfaces (API's) of its corresponding data source. The canonicalizer might also include the corresponding logic for interfacing with that corresponding API to read and/or write data from and to the data source. Thus, canonicalizers bridge between external data sources and the memory image of the data.

The data access component 310 solves the input data 301. If the input data is already canonical and thus processable by the analytics portion 400, then the input data may be directly provided as canonical data 340 to be input to the analytics portion 400.

However, if the input data 301 is not canonical, then data canonicalization components 330 is able to convert the input data 301 into the canonical format. The data canonicalization components 330 are actually a collection of data canonicalization components 330, each capable of converting input data having particular characteristics into canonical form. The collection of data canonicalization components 330 is illustrated as including four canonicalization components 331, 332, 333 and 334. However, the ellipses 335 represents that there may be other numbers of canonicalization components as well, perhaps even fewer that the four illustrated.

The input data 301 may even include a canonicalizer itself as well as an identification of correlated data characteristic(s). The data portion 300 may then register the correlated data characteristics, and provide the canonicalization component to the data canonicalization components 330, where it may be added to the available canonicalization components. If input data is later received that has those correlated characteristics, the data portion 300 may then assign the input data to the correlated canonicalization component. Canonicalization components can also be found dynamically from external sources, such as from defined component libraries on the web. For example, if the schema for a given data source is known but the needed canonicalizer is not present, the canonicalizer can be located from an external component library, provided such a library can be found and contains the needed components. The pipeline might also parse data for which no schema is yet known and compare parse results versus schema information in known component libraries to attempt a dynamic determination of the type of the data, and thus to locate the needed canonicalizer components.

Alternatively, instead of the input data including all of the canonicalization components, the input data may instead provide a transformation definition defining canonicalization transformations. The data canonicalization components 330 may then be configured to convert that transformations definition into a corresponding canonicalization component that enforces the transformations along with zero or more standard default canonicalization transformation. This represents an example of a case in which the data portion 300 consumes the input data and does not provide corresponding canonicalized data further down the pipeline. In perhaps most cases, however, the input data 301 results in corresponding canonicalized data 340 being generated.

In one embodiment, the data portion 300 may be configured to assign input data to the data canonicalization component on the basis of a file type and/or format type of the input data. Other characteristics might include, for example, a source of the input data. A default canonicalization component may be assigned to input data that does not have a designated corresponding canonicalization component. The default canonicalization component may apply a set of rules to attempt to canonicalize the input data. If the default canonicalization component is not able to canonicalize the data, the default canonicalization component might trigger the authoring component 140 of FIG. 1 to prompt the user to provide a schema definition for the input data. If a schema definition does not already exist, the authoring component 140 might present a schema definition assistant to help the author generate a corresponding schema definition that may be used to transform the input data into canonical form. Once the data is in canonical form, the schema that accompanies the data provides sufficient description of the data that the rest of the pipeline 201 does not need new code to interpret the data. Instead, the pipeline 201 includes code that is able to interpret data in light of any schema that is expressible an accessible schema declaration language.

Regardless, canonical data 340 is provided as output data from the data portion 300 and as input data to the analytics portion 400. The canonical data might include fields that include a variety of data types. For instance, the fields might includes simple data types such as integers, floating point numbers, strings, vectors, arrays, collections, hierarchical structures, text, XML documents, tables, lists, SQL database query results, BI (business intelligence) cube query results, graphical information such as 2D drawings and 3D visual models in various formats, or even complex combinations of these various data types. As another advantage, the canonicalization process is able to canonicalize a wide variety of input data. Furthermore, the variety of input data that the data portion 300 is able to accept is expandable. This is helpful in the case where multiple applications are combined as will be discussed later in this description.

FIG. 4 illustrates analytics portion 400 which represents an example of the analytics portion 220 of the pipeline 201 of FIG. 2. The data portion 300 provided the canonicalized data 401 to the data-application binder 410. While the canonicalized data 401 might have any canonicalized form, and any number of parameters, where the form and number of parameters might even differ from one piece of input data to another. For purposes of discussion, however, the canonical data 401 has fields 402A through 402H, which may collectively be referred to herein as “fields 402”.

On the other hand, the analytics portion 400 includes a number of application parameters 411. The type and number of application parameters may differ according to the application. However, for purposes of discussion of a particular example, the application parameters 411 will be discussed as including application parameters 411A, 411B, 411C and 411D. In one embodiment, the identity of the application parameters, and the analytical relationships between the application parameters may be declaratively defined without using imperative coding.

A data-application binder 410 intercedes between the canonicalized data fields 402 and the application parameters 411 to thereby provide bindings between the fields. In this case, the data field 402B is bound to application parameter 411A as represented by arrow 403A. In other words, the value from data field 402B is used to populate the application parameter 411A. Also, in this example, the data field 402E is bound to application parameter 411B (as represented by arrow 403B), and data field 402H is bound to application parameter 411C (as represented by arrow 403C).

The data fields 402A, 402C, 402D, 402F and 402G are not shown bound to any of the application parameters. This is to emphasize that not all of the data fields from input data are always required to be used as application parameters. In one embodiment, one or more of these data fields may be used to provide instructions to the data-application binder 410 on which fields from the canonicalized data (for this canonicalized data or perhaps any future similar canonicalized data) are to be bound to which application parameter. This represents an example of the kind of analytics data 221 that may be provided to the analytics portion 220 of FIG. 2. The definition of which data fields from the canonicalized data are bound to which application parameters may be formulated in a number of ways. For instance, the bindings may be 1) explicitly set by the author at authoring time, 2) explicit set by the user at use time (subject to any restrictions imposed by the author), 3) automatic binding by the authoring component 240 based on algorithmic heuristics, and/or 4) prompting by the authoring component of the author and/or user to specify a binding when it is determined that a binding cannot be made algorithmically. Thus bindings may also be resolved as part of the application logic itself.

The ability of an author to define which data fields are mapped to which application parameters gives the author great flexibility in being able to use symbols that the author is comfortable with to define application parameters. For instance, if one of the application parameters represents pressure, the author can name that application parameter “Pressure” or “P” or any other symbol that makes sense to the author. The author can even rename the application parameter which, in one embodiment, might cause the data application binder 410 to automatically update to allow bindings that were previously to the application parameter of the old name to instead be bound to the application parameter of the new name, thereby preserving the desired bindings. This mechanism for binding also allows binding to be changed declaratively at runtime.

The application parameter 411D is illustrated with an asterisk to emphasize that in this example, the application parameter 411D was not assigned a value by the data-application binder 410. Accordingly, the application parameter 411D remains an unknown. In other words, the application parameter 411D is not assigned a value.

Expression engine 420 may receive application parameters 411 as input, process an application defined by expressions 421 using a solver 440, and generate application parameters 411 as output. Expression engine 420 may be implemented in software or hardware, and may apply techniques known to one of skill in the art. In some embodiments, expression engine may be written using programming languages known to one of skill in the art, and be executable on a variety of computer processors, such as processors on a server computer, a personal computer, or a mobile phone. In some embodiments, expression engine 420 may be an application that runs on a web browser, such as a web browser on a personal computer or a mobile phone.

Expression engine 420 may contain an application defined by expressions 421. Application defined by expressions 421 may be stored on a computer-readable medium and may processed by expression engine 420 so that expression engine may solve expressions in application defined by expressions 421.

Application defined by expressions 421 may contain a list or set of expressions, which may be created by an author of the application or may be created in any suitable manner. Application defined by expressions 421 may contain expressions in any of the forms discussed above. Further, application defined by expressions 421 may contain expressions in the form of equations 431, rules 432 and constraints 433.

The term “equation” as used herein aligns with the term as it is used in the field of mathematics.

The term “rules” as used herein means a conditional statement where if one or more conditions are satisfied (the conditional or “if” portion of the conditional statement), then one or more actions are to be taken (the consequence or “then” portion of the conditional statement). A rule is applied to the application parameters if one or more application parameters are expressed in the conditional statement, or one or more application parameters are expressed in the consequence statement.

The term “constraint” as used herein means that a restriction is applied to one or more application parameters. For instance, in a city-planning application, a particular house element may be restricted to placement on a map location that has a subset of the total possible zoning designations. A bridge element may be restricted to below a certain maximum length, or a certain number of lanes.

An author that is familiar with the application may provide expressions of these equations, rules and constraint that apply to that application. In the case of simulations, the author might provide an appropriate simulation engine that provides the appropriate simulation relationships between application parameters. The expression engine 420 may provide a mechanism for the author to provide a natural symbolic expression for equations, rules and constraints. For example, an author of a thermodynamics related application may simply copy and paste equations from a thermodynamics textbook. The ability to bind application parameters to data fields allows the author to use whatever symbols the author is familiar with (such as the exact symbols used in the author's relied-upon textbooks) or the exact symbols that the author would like to use.

Expression engine 420 may include a solver 440. Solver 440 may include a plurality of solvers, and may be extensible. In some embodiments, for example, one or more simulations may be incorporated as part of the analytical relationships provided a corresponding simulation engine is provided and registered as a solver.

Prior to solving, expression engine 420 may identify which of the application parameters are to be solved for (i.e., hereinafter, the “output application variable” if singular, or “output application variables” if plural, or “output application variable(s)” if there could be a single or plural output application variables). The output application variables may be unknown parameters, or they might be known application parameters, where the value of the known application parameter is subject to change in the solve operation. In the example of FIG. 4, after the data-application binding operation, application parameters 411A, 411B and 411C are known, and application parameter 411D is unknown. Accordingly, unknown application parameter 411D might be one of the output application variables. Alternatively or in addition, one or more of the known application parameters 411A, 411B and 411C might also be output application variables. The solver 440 may then solve for the output application variable(s), if possible. In some embodiments, described hereinafter, the solver 440 is able to solve for a variety of output application variables, even within a single application so long as sufficient input application variables are provided to allow the solve operation to be performed. Input application variables might be, for example, known application parameters whose values are not subject to change during the solve operation. For instance, in FIG. 4, if the application parameters 411A and 411D were input application variables, the solver might instead solve for output application variables 411B and 411C instead. In some embodiments, the solver might output any one of a number of different data types for a single application parameter. For instance, some equation operations (such as addition, subtraction, and the like) apply regardless of the whether the operands are integers, floating point, vectors of the same, or matrices of the same.

In some embodiments, even when solver 440 cannot solve for a particular output application variables, the solver 440 might still present a partial solution for that output application variable, even if a full solve to the actual numerical result (or whatever the solved-for data type) is not possible. This allows the pipeline to facilitate incremental development by prompting the author as to what information is needed to arrive at a full solve. This also helps to eliminate the distinction between author time and use time, since at least a partial solve is available throughout the various authoring stages. For an abstract example, suppose that the analytics application includes an equation a=b+c+d. Now suppose that a, c and d are output application variables, and b is an input application variable having a known value of 5 (an integer in this case). In the solving process, the solver 440 is only able to solve for one of the output application variables “d”, and assign a value of 6 (an integer) to the application parameter called “d”, but the solver 440 is not able to solve for “c”. Since “a” depends from “c”, the application parameter called “a” also remains an unknown and unsolved for. In this case, instead of assigning an integer value to “a”, the solver might do a partial solve and output the string value of “c+11” to the application parameter “a”. As previously mentioned, this might be especially helpful when a domain expert is authoring an analytics application, and may serve to provide partial information regarding the content of application parameter “a” and will also serve to cue the author that some further application analytics needs to be provided that allow for the “c” application parameter to be solved for. This partial solve result may be perhaps output in some fashion in the view composition to allow the domain expert to see the partial result.

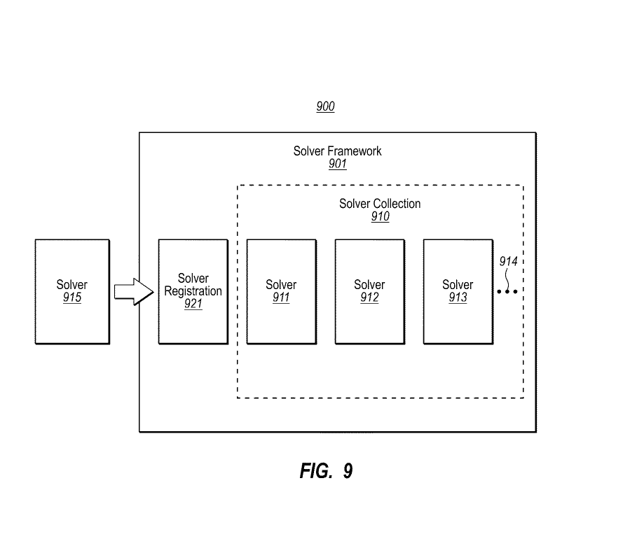

The solver 440 is shown in simplified form in FIG. 4. However, the solver 440 may direct the operation of multiple constituent solvers as will be described with respect to FIG. 9. In FIG. 4, the expression engine 420 may then make the application parameters (including the now known and solved-for output application variables) available as output to be provided to the view portion 500 of FIG. 5.

FIG. 5 illustrates a view portion 500 which represents an example of the view portion 230 of FIG. 2. The view portion 500 receives the application parameters 411 from the analytics portion 400 of FIG. 4. The view portion also includes a view components repository 520 that contains a collection of view components. For example, the view components repository 520 in this example is illustrated as including view components 521 through 524, although the view components repository 520 may contain any number of view components. The view components each may include zero or more input parameters. For example, view component 521 does not include any input parameters. However, view component 522 includes two input parameters 542A and 542B. View component 523 includes one input parameter 543, and view component 524 includes one input parameter 544. That said, this is just an example. The input parameters may, but need not necessary, affect how the visual item is rendered. The fact that the view component 521 does not include any input parameters emphasizes that there can be views that are generated without reference to any application parameters. Consider a view that comprises just fixed (built-in) data that does not change. Such a view might for example constitute reference information for the user. Alternatively, consider a view that just provides a way to browse a catalog, so that items can be selected from it for import into an application.

Each view component 521 through 524 includes or is associated with corresponding logic that, when executed by the view composition component 540 using the corresponding view component input parameter(s), if any, causes a corresponding view item to be placed in virtual space 550. That virtual item may be a static image or object, or may be a dynamic animated virtual item or object. For instance, each of view components 521 through 524 are associated with corresponding logic 531 through 534 that, when executed causes the corresponding virtual item 551 through 554, respectively, to be rendered in virtual space 550. The virtual items are illustrated as simple shapes. However, the virtual items may be quite complex in form perhaps even including animation. In this description, when a view item is rendered in virtual space, that means that the view composition component has authored sufficient instructions that, when provided to the rendering engine, the rendering engine is capable if displaying the view item on the display in the designated location and in the designated manner.

The view components 521 through 524 may be provided perhaps even as view data to the view portion 500 using, for example, the authoring component 240 of FIG. 2. For instance, the authoring component 240 might provide a selector that enables the author to select from several geometric forms, or perhaps to compose other geometric forms. The author might also specify the types of input parameters for each view component, whereas some of the input parameters may be default input parameters imposed by the view portion 500. The logic that is associated with each view component 521 through 524 may be provided also a view data, and/or may also include some default functionality provided by the view portion 500 itself.

The view portion 500 includes an application-view binding component 510 that is configured to bind at least some of the application parameters to corresponding input parameters of the view components 521 through 524. For instance, application parameter 411A is bound to the input parameter 542A of view component 522 as represented by arrow 511A. Application parameter 411B is bound to the input parameter 542B of view component 522 as represented by arrow 511B. Also, application parameter 411D is bound to the input parameters 543 and 544 of view components 523 and 524, respectively, as represented by arrow 511C. The application parameter 411C is not shown bound to any corresponding view-component parameter, emphasizing that not all application parameters need be used by the view portion of the pipeline, even if those application parameters were essential in the analytics portion. Also, the application parameter 411D is shown bound to two different input parameters of view components representing that the application parameters may be bound to multiple view component parameters. In one embodiment, The definition of the bindings between the application parameters and the view-component parameters may be formulated by 1) being explicitly set by the author at authoring time, 2) explicit set by the user at use time (subject to any restrictions imposed by the author), 3) automatic binding by the authoring component 240 based on algorithmic heuristics, and/or 4) prompting by the authoring component of the author and/or user to specify a binding when it is determined that a binding cannot be made algorithmically.

As previously mentioned, the view item may include an animation. To take a simple example, consider for example a bar chart that plots a company's historical and projected revenues, advertising expenses, and profits by sales region at a given point in time (such as a given calendar quarter). A bar chart could be drawn for each calendar quarter in a desired time span. Now, imagine that you draw one of these charts, say the one for the earliest time in the time span, and then every half second replace it with the chart for the next time span (e.g., the next quarter). The result will be to see the bars representing profit, sales, and advertising expense for each region change in height as the animation proceeds. In this example, the chart for each time period is a “cell” in the animation, where the cell shows an instant between movements, where the collection of cells shown in sequence simulates movement. Conventional animation models allow for animation over time using built-in hard-coded chart types.

However, using the pipeline 201, by contrast, any kind of visual can be animated, and the animation can be driven by varying any one or any combination of the parameters of the visual component. To return to the bar chart example above, imagine that instead of animating by time, it is animated by advertising expense. Each “cell” in this animation is a bar chart showing sales and profits over time for a given value of advertising expense. Thus, as the advertising expense is varied, the bars grow and shrink in response to the change in advertising expense.

The power of animated data displays is that they make very apparent to the eye what parameters are most sensitive to change in other parameters, because you immediately see how quickly and how far each parameter's values change in response to the varying of the animation parameter.

The pipeline 201 is also distinguished in its ability to animate due to the following characteristics:

First, the sequences of steps for the animation variable can be computed by the analytics of the application, versus being just a fixed sequence of steps over a predefined range. For example, in the example of varying the advertising expense as the animation variable, imagine that what is specified is to “animate by advertising expense where advertising expense is increased by 5% for each step” or “where advertising expense is 10% of total expenses for that step”. A much more sophisticated example is “animate by advertising expense where advertising expense is optimized to maximize the rate of change of sales over time”. In other words, the solver will determine a set of steps for advertising spend over time (i.e., for each successive time period such as quarter) such that the rate of growth of sales maximized. Here the user presumably wants to see not only how fast sales can be made to grow by varying advertising expense, but also wants to learn the quarterly amounts for the advertising expense that achieve this growth (the sequence of values could be plotted as part of the composite visual).

Second, any kind of visual can be animated, not just traditional data charts. For example, consider a Computer-Aided Design (CAD) model of a jet engine that is a) to be animated by the air speed parameter and 2) where the rotational speed of the turbine is a function of the air speed and 3) where the temperature of the turbine bearings is a function of the air speed. Jet engines have limits on how fast turbines can be rotated before either the turbine blades lose integrity or the bearing overheats. Thus, in this animation it may be desired that as air speed is varied the color of the turbine blades and bearing could be varied from blue (safe) to red (critical). The values for “safe” and “critical” turbine RPM and bearing temperature may well be calculated by the model based on physical characteristics of those parts. Now, as the animation varies the air speed over a defined range, the turbine blades and bearing may each change color. What is now interesting is to notice which reaches critical first, and if either undergoes a sudden (runway) run to critical. These kinds of effects are hard to discern by looking at a chart or at a sequence of drawings, but become immediately apparent in an animation. This is but one example of animating an arbitrary visual (CAD model) by an arbitrary parameter (air speed), with the animation affecting yet other arbitrary parameters (turbine RPM and bearing temp). Any parameter(s) of any visual(s) can be animated according to any desired parameter(s) that are to serve as the animation variables.

Third, the pipeline 201 can be stopped mid stream so that data and parameters may be modified by the user, and the animation then restarted or resumed. Thus, for example, in the jet engine example, if runaway heating is seen to start at a given air speed, the user may stop the animation at the point the runaway beings, modify some engine design criterion, such as the kind of bearing or bearing surface material, and then continue the animation to see the effect of the change.

As with other of the capabilities discussed herein, animations can be defined by the author, and/or left open for the user to manipulate to test various scenarios. For example, the application may be authored to permit some visuals to be animated by the user according to parameters the user himself selects, and/or over data ranges for the animation variable that the user selects (including the ability to specify computed ranges should that be desired). Such animations can also be displayed side by side as in the other what-if comparison displays. For example, a user could compare an animation of sales and profits over time, animated by time, in two scenarios with differing prevailing interest rates in the future, or different advertising expenses ramps. In the jet engine example, the user could compare the animations of the engine for both the before and after cases of changing the bearing design.

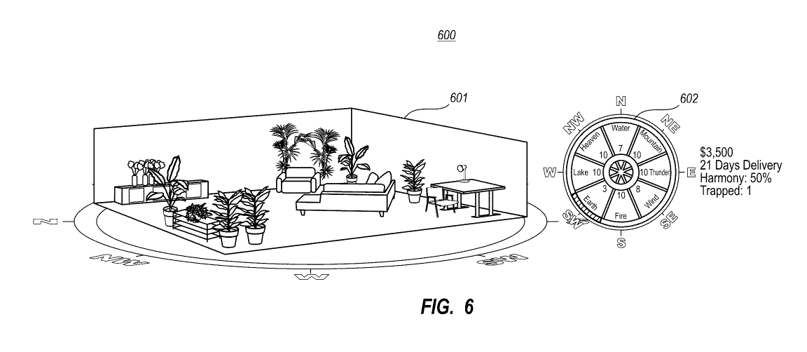

At this point, a specific example of how the composition framework may be used to actually construct a view composition will be described with respect to FIG. 6, which illustrated 3-D renderings of a view composition 600 that includes a room layout 601 with furniture laid out within the room, and also includes a Feng Shui meter 602. This example is provided merely to show how the principles described herein can apply to any arbitrary view composition, regardless of the domain. Accordingly, the example of FIG. 6, and any other example view composition described herein, should be viewed strictly as only an example that allows the abstract concept to be more fully understood by reference to non-limiting concrete examples, and not defining the broader scope of the invention. The principles described herein may apply to construct an enumerable variety of view compositions. Nevertheless, reference to a concrete example can clarify the broader abstract principles.

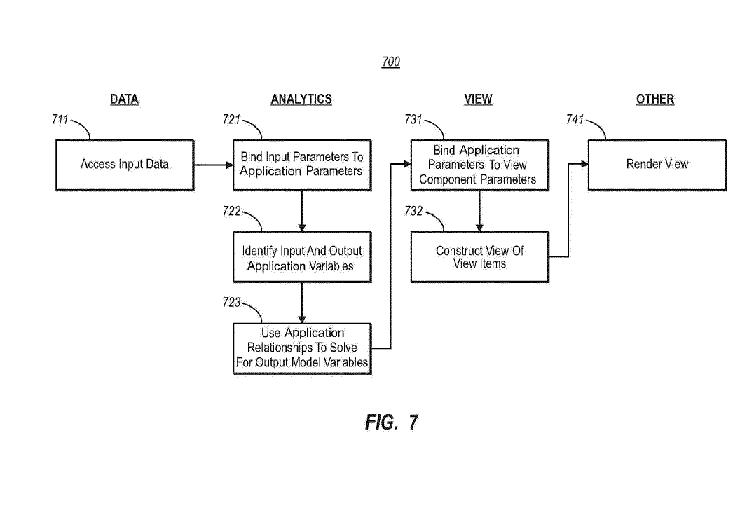

FIG. 7 illustrates a flowchart of a method 700 for generating a view construction. The method 700 may be performed by the pipeline environment 200 of FIG. 2, and thus will be described with frequent reference to the pipeline environment 200 of FIG. 2, as well as with reference to FIG. 3 through 5, which each show specific portions of the pipeline of FIG. 2. While the method 700 may be performed to construct any view composition, the method 700 will be described with respect to the view composition 600 of FIG. 6. Some of the acts of the method 700 may be performed by the data portion 210 of FIG. 2 and are listed in the left column of FIG. 7 under the header “Data”. Other of the acts of the method 700 may be performed by the analytics portion 220 of FIG. 2, and are listed in the second from the left column of FIG. 7 under the header “Analytics”. Other of the acts of the method are performed by the view portion 230 of FIG. 2, and are listed in the second from the right column under the header “View”. One of the acts may be performed by a rendering module and is listed in the right column under the header other. Any conventional or yet to be developed rendering module may be used to render a view composition constructed in accordance with the principles described herein.

Referring to FIG. 7, the data portion accesses input data that at least collectively affects what visual items are displayed or how a given one or more of the visual items are displayed (act 711). For instance, referring to FIG. 6, the input data might include view components for each of the items of furniture. For instance, each of the couch, the chair, the plants, the table, the flowers, and even the room itself may be represented by a corresponding view component. The view component might have input parameters that are suitable for the view component. If animation were employed, for example, some of the input parameters might affect the flow of the animation. Some of the parameters might affect the display of the visual item, and some parameters might not.

For instance, the room itself might be a view component. Some of the input parameters might include the dimensions of the room, the orientation of the room, the wall color, the wall texture, the floor color, the floor type, the floor texture, the position and power of the light sources in the room, and so forth. There might also be room parameters that do not necessarily get reflected in this view composition, but might get reflected in other views and uses of the room component. For instance, the room parameter might have a location of the room expressed in degrees, minutes, and seconds longitude and latitude. The room parameter might also include an identification of the author of the room component, and the average rental costs of the room.

The various components within the room may also be represented by a corresponding parameterized view component. For instance, each plant may be configured with an input parameter specifying a pot style, a pot color, pot dimensions, plant color, plant resiliency, plant dependencies on sunlight, plant daily water intake, plant daily oxygen production, plant position and the like. Once again, some of these parameters may affect how the display is rendered and others might not, depending on the nature of what is being displayed.

The Feng Shui meter 602 may also be a view component. The meter might include input parameters such as a diameter, a number of wedges to be contained in the diameter of the meter, a text color and the like. The various wedges of the Feng Shui meter may also be view components. In that case, the input parameters to the view components might be a title (e.g., water, mountain, thunder, wind, fire, earth, lake, heaven), perhaps a graphic to appear in the wedge, a color hue, or the like.

The analytics portion binds the input data to the application parameters (act 721), determines the output application variables (act 722), and uses the application-specific analytical relationships between the application parameters to solve for the output application variables (act 723). The binding operation of act 721 has been previously discussed, and essentially allows flexibility in allowing the author to define the application analytics equations, rules and constraints using symbols that the application author is comfortable with.

The identification or the output application variables may differ from one solving operation to the next. Even though the application parameters may stay the same, the identification of which application parameters are output application variables will depend on the availability of data to bind to particular application parameters. This has remarkable implications in terms of allowing a user to perform what-if scenarios in a given view composition.

For instance, in the Fung Shui room example of FIG. 6, suppose the user has bought a new chair to place in their living room. The user might provide the design of the room as data into the pipeline. This might be facilitated by the authoring component prompting the user to enter the room dimensions, and perhaps provide a selection tool that allows the user to select virtual furniture to drag and drop into the virtual room at appropriate locations that the actual furniture is placed in the actual room. The user might then select a piece of furniture that may be edited to have the characteristics of the new chair purchased by the user. The user might then drag and drop that chair into the room. The Feng Shui meter 602 would update automatically. In this case, the position and other attributes of the chair would be input application variables, and the Feng Shui scores would be output application variables. As the user drags the virtual chair to various positions, the Feng Shui scores of the Feng Shui meter would update, and the user could thus test the Feng Shui consequences of placing the virtual chair in various locations. To avoid the user from having to drag the chair to every possible location to see which gives the best Feng Shui, the user can get local visual clues (such as, for example, gradient lines or arrows) that tell the user whether moving the chair in a particular direction from its current location makes things better or worse, and how much better or worse.

However, the user could also do something else that is unheard of in conventional view composition. The user could actually change the output application variables. For instance, the user might indicate the desired Feng Shui score in the Feng Shui meter, and leave the position of the virtual chair as the output application variable. The solver would then solve for the output application variable and provide a suggested position or positions of the chair that would achieve at least the designated Feng Shui score. The user may choose to make multiple parameters output application variables, and the system may provide multiple solutions to the output application variables. This is facilitated by a complex solver that is described in further detail with respect to FIG. 9.

Returning to FIG. 7, once the output application variables are solved for, the application parameters are bound to the input parameters of the parameterized view components (act 731). For instance, in the Feng Shui example, after the unknown Feng Shui scores are solved for, the scores are bound as input parameters to Feng Shui meter view component, or perhaps to the appropriate wedge contained in the meter. Alternatively, if the Feng Shui scores were input application variables, the position of the virtual chair may be solved for and provided as an input parameter to the chair view component.

A simplified example will now be presented that illustrates the principles of how the solver can rearrange equations and change the designation of input and output application variables all driven off of one analytical application. The user herself does not have to rearrange the equations. The simplified example may not accurately represent Feng Shui rules, but illustrates the principle nevertheless. Suppose the total Feng Shui (FS) of the room (FSroom) equals the FS of a chair (FSchair) and the FS of a plant (FSplant). Suppose FSchair is equal to a constant A times the distance d of the chair from the wall. Suppose FSplant is a constant, B. The total FS of the room is then: FSroom=A*d+B. If d is an input application variable, then FSroom is an output application variable and its value, displayed on the meter, changes as user repositions the chair. Now suppose the user now clicks on the meter making it an input application variable and shifting d into unknown output application variable status. In this case, the solver effectively and internally rewrites the equation above as d=(FSroom−B)/A. In that case, the view component can move the chair around, changing d, its distance from the wall, as the user changes the desired value, FSroom, on the meter.

The view portion then constructs a view of the visual items (act 732) by executing the construction logic associated with the view component using the input parameter(s), if any, to perhaps drive the construction of the view item in the view composition. The view construction may then be provided to a rendering module, which then uses the view construction as rendering instructions (act 741).

In one embodiment, the processing of constructing a view is treated as a data transformation that is performed by the solver. That is, for a given kind of view (e.g., consider a bar chart), there is an application that may include rules, equations, and constraints that generates the view by transforming the input data into a displayable output data structure (called a scene graph) which encodes all the low level geometry and associated attributes needed by the rendering software to drive the graphics hardware. In the bar chart example, the input data would be for example the data series that is to be plotted, along with attributes for things like the chart title, axis labels, and so on. The application that generates the bar would have rules, equations, and constraints that would do things like 1) count how many entries the data series consists of in order to determine how many bars to draw, 2) calculate the range (min, max) that the data series spans in order to calculate things like the scale and starting/ending values for each axis, 3) calculate the height of the bar for each data point in the data series based on the previously calculated scale factor, 4) count how many characters are in the chart title in order to calculate a starting position and size for the title so that the title will be properly located and centered with respect to the chart, and so forth. In sum, the application that is designed to calculate a set of geometric shapes based on the input data, with those geometric shapes arranged within a hierarchical data structure of type “scene graph”. In other words, the scene graph is an output variable that the application solves for based on the input data. Thus, an author can design entirely new kinds of views, customized existing views, and compose preexisting views into composites, using the same framework that the author uses to author, customize, and compose any kind of application. Thus, authors who are not programmers can create new views without drafting new code.

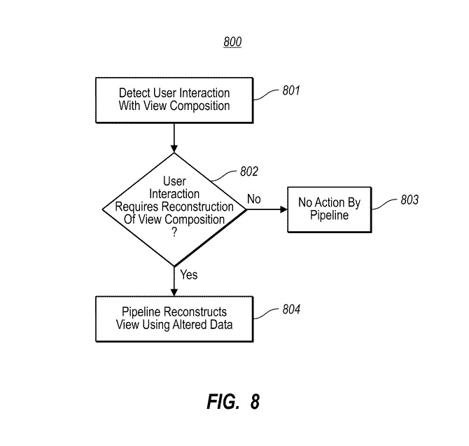

Returning to FIG. 2, recall that the user interaction response module 250 detects when the user interacts with the view composition, and causes the pipeline to respond appropriately. FIG. 8 illustrates a flowchart of a method 800 for responding to user interaction with the view composition. In particular, the user interaction response module may determine which components of the pipeline perform further work in order to regenerate the view, and also provides data represented the user interaction, or that is at least dependent on the user interaction, to the pipeline components. In one embodiment, this is done via a transformation pipeline that runs in the reverse (upstream) view/analytics/data direction and is parallel to the (downstream) data/analytics/view pipeline.

Interactions are posted as events into the upstream pipeline. Each transformer in the data/analytics/view pipeline provides an upstream transformer that handles incoming interaction data. These transformers can either be null (passthroughs, which get optimized out of the path) or they can perform a transformation operation on the interaction data to be fed further upstream. This provides positive performance and responsiveness of the pipeline in that 1) interaction behaviors that would have no effect on upstream transformations, such as a view manipulation that has no effect on source data, can be handled at the most appropriate (least upstream) point in the pipeline and 2) intermediate transformers can optimize view update performance by sending heuristically-determined updates back downstream, ahead of the final updates that will eventually come from further upstream transformers. For example, upon receipt of a data edit interaction, a view-level transformer could make an immediate view update directly into the scene graph for the view (for edits it knows how to interpret), with the final complete update coming later from the upstream data transformer where the source data is actually edited.

When the semantics of a given view interaction have a nontrivial mapping to the needed underlying data edits, intermediate transformers can provide the needed upstream mapping. For example, dragging a point on a graph of a computed result could require a backwards solve that would calculate new values for multiple source data items that feed the computed value on the graph. The solver-level upstream transformer would be able to invoke the needed solve and to propagate upstream the needed data edits.

FIG. 8 illustrates a flowchart of a method 800 for responding to user interaction with the view construction. Upon detecting that the user has interacted with the rendering of a view composition on the display (act 801), it is first determined whether or not the user interaction requires regeneration of the view (decision block 802). This may be performed by the rendering engine raising an event that is interpreted by the user interaction response module 250 of FIG. 2. If the user interaction does not require regeneration of the view (No in decision block 802), then the pipeline does not perform any further action to reconstruct the view (act 803), although the rendering engine itself may perform some transformation on the view. An example of such a user interaction might be if the user were to increase the contrast of the rendering of the view construction, or rotate the view construction. Since those actions might be undertaken by the rendering engine itself, the pipeline need perform no work to reconstruct the view in response to the user interaction.

If, on the other hand, it is determined that the type of user interaction does require regeneration of the view construction (Yes in decision block 802), the view is reconstructed by the pipeline (act 704). This may involve some altering of the data provided to the pipeline. For instance, in the Feng Shui example, suppose the user were to move the position of the virtual chair within the virtual room, the position parameter of the virtual chair component would thus change. An event would be fired informing the analytics portion that the corresponding application parameter representing the position of the virtual chair should be altered as well. The analytics component would then resolve for the Feng Shui scores, repopulate the corresponding input parameters of the Feng Shui meter or wedges, causing the Feng Shui meter to update with current Feng Shui scores suitable for the new position of the chair.

The user interaction might require that application parameters that were previously known are now unknown, and that previously unknown parameters are now known. That is one of several possible examples that might require a change in designation of input and output application variables such that previously designated input application variables might become output application variables, and vice versa. In that case, the analytics portion would solve for the new output application variable(s) thereby driving the reconstruction of the view composition.

Solver Framework

FIG. 9 illustrates a solver environment 900 that may represent an example of the solver 440 of FIG. 4. The solver environment 900 may be implemented in software, hardware, or a combination. The solver environment 900 includes a solver framework 901 that manages and coordinates the operations of a collection 910 of specialized solvers. The collection 910 is illustrated as including three specialized solvers 911, 912 and 913, but the ellipsis 914 represents that there could be other numbers (i.e., more than three or less than three) of specialized solvers as well. Furthermore, the ellipsis 914 also represents that the collection 910 of specialized solves is extensible. As new specialized solvers are discovered and/or developed that can help with the application analytics, those new specialized solvers may be incorporated into the collection 910 to supplement the existing specialized solvers, or perhaps to replace one or more of the existing solvers. For example, FIG. 9 illustrates that a new solver 915 is being registered into the collection 910 using the solver registration module 921. As one example, a new solver might be perhaps a simulation solver which accepts one or more known values, and solves for one or more unknown values. Other examples include solvers for systems of linear equations, differential equations, polynomials, integrals, root-finders, factorizers, optimizers, and so forth. Every solver can work in numerical mode or in symbolic mode or in mixed numeric-symbolic mode. The numeric portions of solutions can drive the parameterized rendering downstream. The symbolic portions of the solution can drive partial solution rendering.

The collection of specialized solvers may include any solver that is suitable for solving for the output application variables. If, for example, the application is to determine drag of a bicycle, the solving of complex calculus equations might be warranted. In that case, a specialized complex calculus solver may be incorporated into the collection 910 to perhaps supplement of replace an existing equations solver. In one embodiment, each solver is designed to solve for one or more output application variables in a particular kind of analytics relationship. For example, there might be one or more equation solvers configured to solve for unknowns in an equation. There might be one or more rules solvers configured to apply rules to solve for unknowns. There might be one or more constraints solvers configured to apply constraints to thereby solve for unknowns. Other types of solves might be, for example, a simulation solver which performs simulations using input data to thereby construct corresponding output data.

The solver framework 901 is configured to coordinate processing of one or more or all of the specialized solvers in the collection 910 to thereby cause one or more output application variables to be solved for. The solver framework 901 is then configured to provide the solved for values to one or more other external components. For instance, referring to FIG. 2, the solver framework 901 may provide the application parameter values to the view portion 230 of the pipeline, so that the solving operation thereby affects how the view components execute to render a view item, or thereby affect other data that is associated with the view item. As another potential effect of solving, the application analytics themselves might be altered. For instance, as just one of many examples in which this might be implemented, the application might be authored with modifiable rules set so that, during a given solve, some rule(s) and/or constraint(s) that are initially inactive become activated, and some that are initially activated become inactivated. Equations can be modified this way as well.

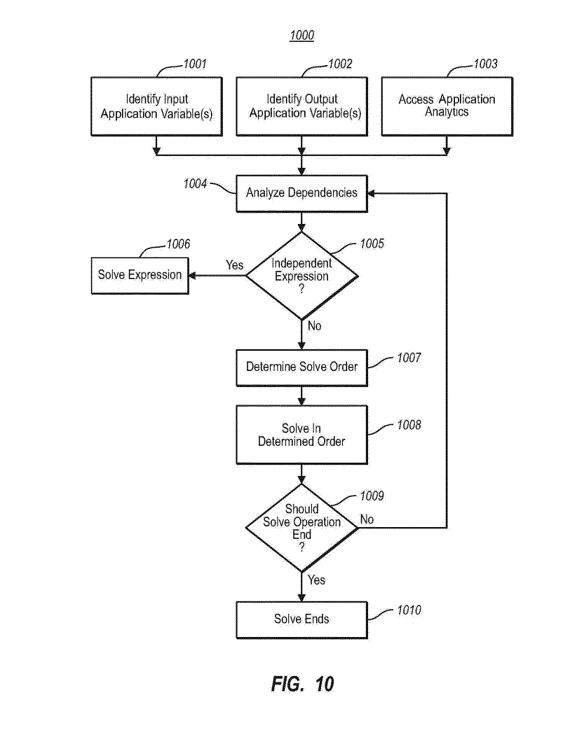

FIG. 10 illustrates a flowchart of a method 1000 for the solver framework 901 to coordinate processing amongst the specialized solvers in the collection 910. The method 1000 of FIG. 10 will now be described with frequent reference to the solver environment 900 of FIG. 9.

The solver framework begins a solve operation by identifying which of the application parameters are input application variables (act 1001), and which of the application parameters are output application variables (act 1002), and by identifying the application analytics that define the relationship between the application parameters (act 1003). Given this information, the solver framework analyzes dependencies in the application parameters (act 1004). Even given a fixed set of application parameters, and given a fixed set of application analytics, the dependencies may change depending on which of the application parameters are input application variables and which are output application variables. Accordingly, the system can infer a dependency graph each time a solve operation is performed using the identity of which application parameters are input, and based on the application analytics. The user need not specify the dependency graph for each solve. By evaluating dependencies for every solve operation, the solver framework has the flexibility to solve for one set of one or more application variables during one solve operation, and solve for another set of one or more application variables for the next solve operation. In the context of FIGS. 2 through 5, that means greater flexibility for a user to specify what is input and what is output by interfacing with the view composition.

In some solve operations, the application may not have any output application variables at all. In that case, the solve will verify that all of the known application parameter values, taken together, satisfy all the relationships expressed by the analytics for that application. In other words, if you were to erase any one data value, turning it into an unknown, and then solve, the value that was erased would be recomputed by the application and would be the same as it was before. Thus, an application that is loaded can already exist in solved form, and of course an application that has unknowns and gets solves now also exists in solved form. What is significant is that a user interacting with a view of a solved application is nevertheless able to edit the view, which may have the effect of changing a data value or values, and thus cause a re-solve that will attempt to recompute data values for output application variables so that the new set of data values is consistent with the analytics. Which data values a user can edit (whether or not an application starts with output application variables) is controlled by the author; in fact, this is controlled by the author defining which variables represented permitted unknowns.

In some embodiments, solver framework may create an expression tree in analyzing dependencies in the application parameters (act 1004). For example, an output application variable may be defined by a first expression. The first expression may have several operands. To solve the first expression, one may need to first solve for each of the operands of the first expression. For example, the first expression may have three operands, where the first operand is defined by a second expression, the second operand is defined by a third expression, and the third operand is defined by a fourth expression. Each of the second, third, and fourth expressions may have several operands, and each of these operands may in turn be defined by additional expressions.

The process of creating an expression tree may continue until any appropriate stopping point. In some embodiments, the process of creating the expression tree may continue until no dependencies remain. In some embodiments, parameters may have recursive definitions, and checks for recursive definitions may be applied using techniques known to one of ordinary skill in the art. In other embodiments, the creation of the expression tree may continue until an expression has been identified that may be solved.

After dependencies have been analyzed at act 1004, one of the dependent expressions is selected and it is determined whether the selected expression is an independent expression (act 1005). If the selected expression has one or more unknowns that may be independently solved without first solving for other unknowns in other expressions (Yes in act 1005), then those expressions may be solved at any time (act 1006), even perhaps in parallel with other solving steps. If there are expressions that have unknowns that cannot be solved without first solving for an unknown in another expression (No in act 1005), then the dependent expressions may be solved in a specified order.

In the case of expressions that have interconnected solve dependencies from other expressions, an order of execution of the specialized solvers may be determined based on the analyzed dependencies (act 1007). The solvers may then be executed in the determined order (act 1008). In one example, in the case where the application analytics are expressed as equations, constraints, and rules, the order of execution may be as follows 1) equations with dependencies or that are not fully solvable as an independent expression are rewritten as constraints 2) the constraints are solved, 3) the equations are solved, and 4) the rules are solved. The rules solving may cause the data to be updated.

Once the solvers are executed in the designated order, it is then determined whether or not solving is complete (decision block 1009). The solving process may be complete if, for example, all of the output application variables are solved for, or if it is determined that even though not all of the output application variables are solved for, the specialized solvers can do nothing further to solve for any more of the output application variables. If the solving process is not complete (No in decision block 1009), the process returns back to the analyzing of dependencies (act 1004). This time, however, the identity of the input and output application variables may have changed due to one or more output application variables being solved for. On the other hand, if the solving process is complete (Yes in decision block 1009) the solve ends (act 1010). However, if an application cannot be fully solved because there are too many output application variables, the application nevertheless may succeed in generating a partial solution where the output application variable have bee assigned symbolic values reflective of how far the solve was able to proceed. For example, if an application has an equation A=B+C, and B is known to be “2” and is an input application variable but C is an output application variable and A is also an output application variable and needs to be solved for, the application solver cannot product a numerical value for A since while B is known C is unknown; so instead of a full solve, the solver returns “2+C” as the value for A. It is thus clear to the author what additional variable needs to become known, either by supplying it a value or by adding further rules/equations/constraints or simulations that can successfully produce the needed value from other input data.

This method 1000 may repeat each time the solver framework detects that there has been a change in the value of any of the known application parameters, and/or each time the solver framework determines that the identity of the known and unknown application parameters has changed. Solving can proceed in at least two ways. First, if an application can be fully solved symbolically (that is, if all equations, rules, and constraints can be algorithmically rewritten so that a computable expression exists for each unknown) then that is done, and then the application is computed. In other words, data values are generated for each unknown, and/or data values that are permitted to be adjusted are adjusted. As a second possible way, if an application cannot be fully solved symbolically, it is partially solved symbolically, and then it is determined if one or more numerical methods can be used to effect the needed solution. Further, an optimization step occurs such that even in the first case, it is determined whether use of numerical methods may be the faster way to compute the needed values versus performing the symbolic solve method. Although the symbolic method can be faster, there are cases where a symbolic solve may perform so many term rewrites and/or so many rewriting rules searches that it would be faster to abandon this and solve using numeric methods.

Dynamic Distribution of Processing

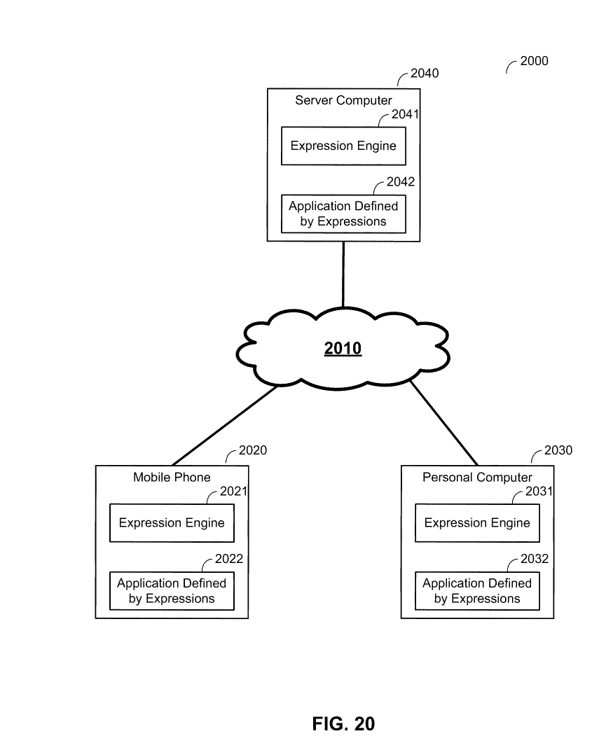

Applicants have appreciated that the execution of an application defined by expressions may be dynamically distributed over more than device. For example, an expression engine may be available on a variety of devices, such as a mobile phone, a personal computer, and a server computer. FIG. 20 illustrates an exemplary environment 2000 in which an application defined by expressions may be executed.

In FIG. 20, various devices may be connected to a network 2010. The devices connected to network 2010 may include, for example, a mobile phone 2020, a personal computer 2030, and a server computer 2040. The invention is not limited to any particular devices and any suitable device may be connected to network 2010. Each device connected to network 2010 may include an expression engine, one or more applications defined by expressions, and data. For example mobile phone 2020 may contain an expression engine 2021, an application defined by expressions 2022, and data 2023; personal computer 2030 may contain an expression engine 2031, an application defined by expressions 2032, and data 2033; and server computer 2040 may contain an expression engine 2041, an application defined by expressions 2042, and data 2043. The expression engine on each device may be the same or may have different capabilities. For example, an expression engine may be customized for the features of a particular device. The application defined by expressions on each device may be the same or may be different. For example, some expressions may be present on one device but may not be present on another device. In some embodiments, expressions may also be transferred from one device to another device. The data on each device may be the same or may be different. For example, private data of a user may only be on that user's device or proprietary data of a company may only be present on the company's server.

How well a particular application may run on a particular device may depend on the capabilities of the device and the resources available to the device. For example, how well an application may run on a device may depend on one or more of the following factors: the processing power of a device, the amount of memory or storage on a device, the user interface of a device, the speed of the network to which the device is attached, or a latency toleration for a user.

In some embodiments, an application defined by expressions may suggest or require in the application itself that certain expressions be solved on particular devices. For example, suppose a company provides an application defined by expressions relating to suggesting particular recipes from a database of thousands of recipes. In creating the application, the company may suggest that any expressions that process a large number of recipes be performed at the server since the server may be able to solve such expressions more efficiently than a customer's mobile phone or computer. Alternatively, the company may require that expressions that process a large number of recipes be solved at the server because the company may want to keep the data proprietary.

In some embodiments, an application defined by expressions may determine dynamically at runtime where expressions will be executed. For example, a device may have high processing power, which may normally suggest the computationally expensive operations be performed on the device. At runtime, however, the device may also be running other computationally expensive operations, and it may provide an improved experience for the user if a computationally expensive operation is sent to another device. In another example, a device may normally be connected to a high-speed network that would allow for the transfer of large amounts of data, but at run time, the network may be slow or not operational.

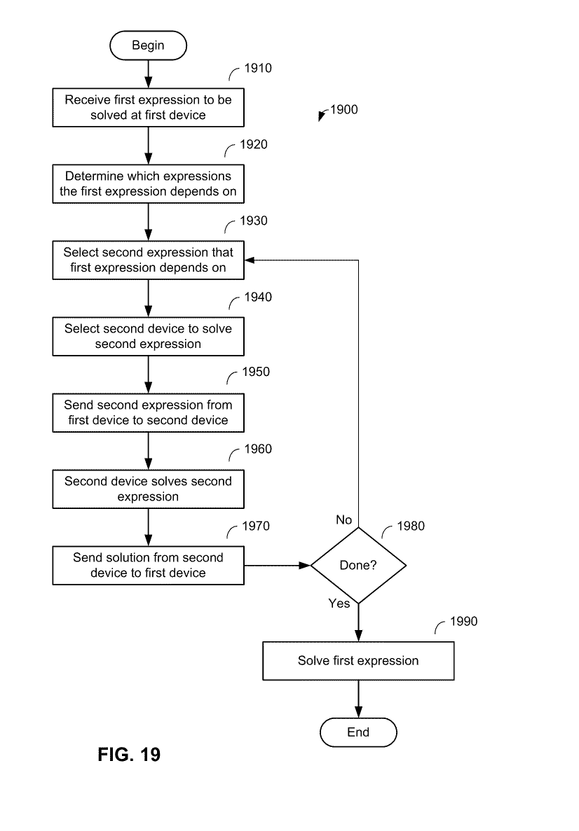

FIG. 19 shows an example of an exemplary process for selecting a device to execute an expression. The process begins at block 1910 where a first device receives an expression to be solved at the first device. The first expression could be any of the expressions described above, and may include an expression representing an output parameter of an application defined by expressions. The first device may be a mobile phone, a personal computer, a server computer, or any other suitable device.

The process continues to block 1920 where the expression engine determines what expressions depend on the first expression. This expression engine may be on the first device or may be an expression engine on another device. In determining dependencies in some embodiments, the expression engine may construct a complete dependency tree for the first expression or may construct a partial dependency tree. Where dependencies have already been determined (for example, when returning to block 1920 from block 1980, described below), this step may not need to be repeated.

The process continues to block 1930 where a second expression is selected such that the first expression depends on the second expression. The first expression may depend directly or indirectly on the first expression, and the second expression may or may not depend on other expressions.

The process continues to block 1940 where a second device is selected to solve the second expression. The second device may be the same as the first device or may be a different device. The second device may be selected by considering any suitable properties, including properties of available devices, the computing environment, the application defined by expressions, the location of data, and the preferences of the user. In some embodiments, some devices may only be available to users who have paid a subscription fee. For example, a user may pay a monthly fee to have access to a server computer with high processing power that is attached to a high speed network.

The process continues to block 1950, where the second expression is sent from the first device to the second device (unless the first and second devices are the same). In some embodiments, other expressions may be sent to the second device to facilitate the second device in solving the second expression. For example, the second expression may depend on other expressions, and the first device may send to the second device these other expressions. In some embodiments, the first device may also send data to the second device that is needed to solve the second expression, but which is not otherwise available to the second device.

The process continues to block 1960 where the second device solves the second expression using any of the solvers described above. In some embodiments, the second expression may depend on other expressions, and the second device may first solve a third expression by calling the process of FIG. 19 recursively and perhaps using a third device.

The process continues to block 1970 where the second device sends the solution to the second expression to the first device. In some embodiments, the second device may also send expressions or data to the first device that may allow the first device to solve the second expression itself in the future to perform further processing using the solution to the second expression.

The process continues to block 1980 where it is determined whether the first device is able provide a solution to the first expression or should obtain solutions for additional expressions. In some embodiments, the first device may provide a solution to the first expression where all of the dependencies of the first expression have been solved. Where the first device should obtain solutions for additional expressions, the process returns to block 1920, where additional dependencies of the first expression may be determined, selected, and solved as described above.

Where the first device is able to produce a solution for the first expression, the process continues to block 1990, where the first device provides a solution for the first expression.

In some embodiments, an application defined by expressions may determine dynamically at runtime the granularity of an expression to be solved by a second device. For example, if the network connecting the first device and the second devices is fast, the first device may send many fine-grained expressions to the second device. Conversely, if the network is slow, the first device may send one coarse-grained expression to the second device. The determination of the granularity of the expression to send to the second device may be based on many factors, including but not limited to the processing power of the first device, the processing power of the second device, data available to the first device, data available to the second device, the user interface of the first device, the user interface of the second device, the speed of a network between the first device and the second device, the latency toleration for the user, or an estimation of resources needed to solve the second expression.

### Example of Dynamic Distribution of Processing

An example is presented of a highly interactive application defined by expressions that may be distributed across multiple devices. In explaining this example, the discussion below may refer to a web browser on a user's computer, but the invention is not limited to this method of presentation, and the user interface need not be presented in a web browser and the device need not be a user's computer. The invention is not limited to any particular user interface or device, and this example is presented to provide non-limiting examples of how an application defined by expressions may be dynamically distributed over multiple devices.

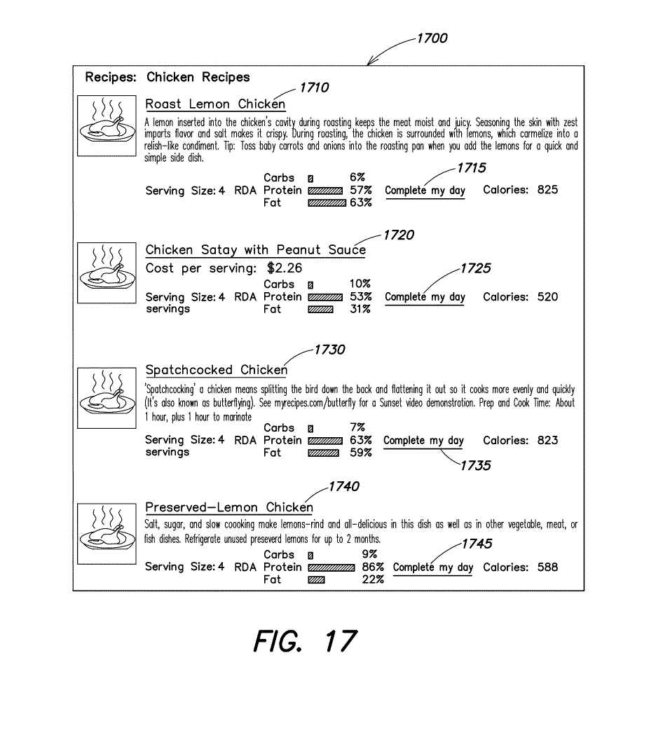

FIG. 17 shows an exemplary user interface 1700 by which a user may invoke an application defined by expressions. In some embodiments, user interface 1700 may be presented in a web browser on a user's personal computer, but user interface 1700 may be presented to a user in any suitable way. In the example of FIG. 17, user interface 1700 displays results from a user searching for chicken recipes. The user may be able to obtain additional information about any of the recipes by selecting links or performing other operations. FIG. 17 may also allow a user to execute an application defined by expressions to obtain additional information about recipes.

User interface 1700 shows four examples of chicken recipes, and each recipe may have a link that allows a user to execute an application defined by expressions. The roast lemon chicken recipe 1710 has link 1715, the chicken satay with peanut sauce recipe 1720 has link 1725, the spatchcocked chicken recipe 1730 has link 1735, and the preserved-lemon chicken recipe 1740 has link 1745. Each of these links may invoke an application defined by expressions, for example an application that suggests other meals for a user to obtain a balanced diet.

In some embodiments, the links 1715, 1725, 1735, and 1745 may be a hypertext link, while in other embodiments the links 1715, 1725, 1735, and 1745 may be replaced with any suitable user-interface element, such as a button.

In some embodiments, the application defined by expressions may be present on the user's computer before the user searches for chicken recipes. In other embodiments, the application defined by expressions may be downloaded to the computer when the user searches for chicken recipes. In other embodiments, the application defined by expressions may be downloaded when the user selects one of links 1715, 1725, 1735, and 1745. When the application defined by expressions is downloaded to the user's computer, it may be loaded into an expression engine located on the user's computer.

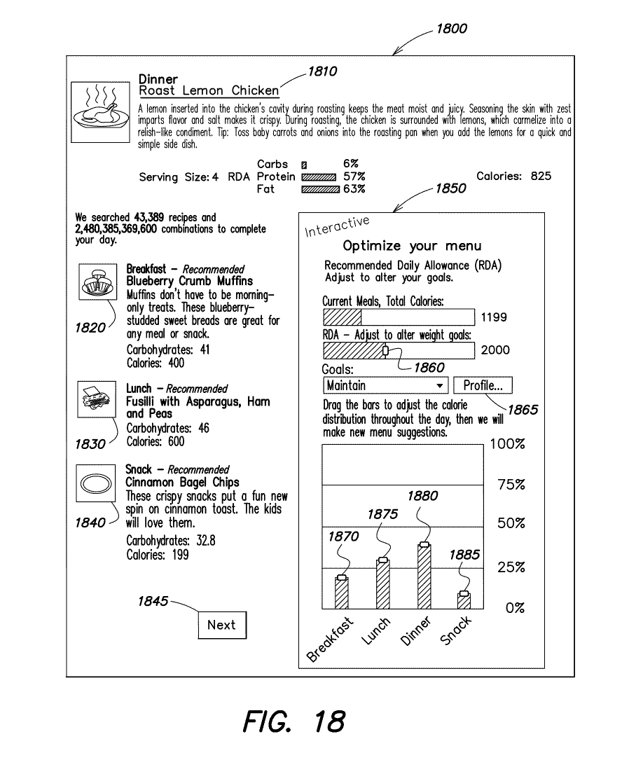

When a user selects one of the “complete my day” links, the expression engine on the user's computer may receive and solve an expression. The output of the expression may be information to allow the presentation of the user interface 1800 of FIG. 18 to the user. In the example user interface of FIG. 18, the selected chicken recipe 1810 is shown along with suggested recipes for breakfast 1820, lunch 1830, and a snack 1840 according to preferences specified by the user. For example, the user may wish to eat a certain number of calories per day and may wish to have a certain number of calories for each meal of the day. If the user does not like the suggested recipes for breakfast, lunch, and dinner, the user may select the “Next” button 1845 to receive different suggestions.

The user may specify preferences in box 1850. For example, the user may specify a recommended daily allowance (RDA) of calories by adjusting slider bar 1860. The user may also specify the percentage of those calories the user would like to have for each meal of the day by adjusting slider bars 1870, 1875, 1880, and 1885. The user's preferences may be stored so that they may be reused the next time the user executes the application.

The complete my day application of FIG. 18 may be highly interactive in that it allows a user to take a variety of actions to change the information that is presented to the user. The user may repeatedly adjust his or her preferred RDA or preferred percentage of calories and each time a change is made, the application may evaluate expressions and present an updated result to the user.

When the user first selects the “complete my day” link to cause the user interface 1800 of FIG. 18 to appear, the expression engine on the user's computer may solve an expression, such as an expression consisting of a function CompleteMyDay( ) which may have one or more arguments. The arguments passed to the CompleteMyDay( ) function may depend on the recipe associated with the link and the personal preferences of the user. Where the user is executing this application for the first time, the personal preferences of the user may not be available and default values may be used.

For example, in some embodiments, where a user clicks on link 1715 associated with roast lemon chicken recipe 1710, the expression engine may receive the expression

CompleteMyDay(Dinner,RDA,[BP,LP,DP,SP])

where Dinner is a symbol representing the roast lemon chicken recipe 1710; RDA is a symbol representing the RDA of calories for the user, which may be stored on the user's computer or may be stored elsewhere; and BP, LP, DP, and SP are symbols that represent, respectively, the user's preferred percentage of calories for breakfast, lunch, dinner, and snack in a given day, which may also be stored on the user's computer or elsewhere.

The expression engine may solve the above expression (and other expressions dependent on the expression). The output of the CompleteMyDay( ) function may be information to allow the presentation of the user interface 1800 of FIG. 18 to the user.

In solving the CompleteMyDay( ) function, the expression engine may solve one or more other expressions. Each of the arguments to the CompleteMyDay( ) function may be expressions solved by the users' computer or by another device. For example, the expression RDA may be solved by retrieving a numerical value for the user's RDA or providing a default value.

The CompleteMyDay( ) function may depend on other expressions. For example, to provide a suggested breakfast, lunch, and snack to the user based on the user's RDA and preferred percentage of calories for those meals, the CompleteMyDay( ) function may depend on one or more of the following expressions present in the application on the user's computer:

server Dinners
server Breakfasts
server Lunches
server Snacks
server CalorieMerit(Calories, Recipe)
GetMeals(BreakfastCalories, LunchCalories, SnackCalories) = (

Rank(Breakfasts, CalorieMerit(BreakfastCalories, *), 10),
Rank(Lunches, CalorieMerit(BreakfastCalories, *), 10),
Rank(Snacks, CalorieMerit(BreakfastCalories, *), 10)

)
GetCombination(TenBreakfasts, TenLunches, TenSnacks) = (...)

The initial keyword “server” may indicate that the following expressions are not defined on the user's computer but may be found on a server computer. Similarly, a keyword “client” could be used to specify that resources may be found on a user's computer. The symbol Dinners may represent all of the possible dinner recipes that are available. Where a large number of recipes are available, it may be desirable to have the recipes available only on a server computer to conserve resources.

The function GetMeals( ) is an expression that may be defined as indicated above. This function may take as arguments the user's desired number of calories and returns a list of ten breakfasts, ten lunches, and ten snacks that satisfy the user's preferences. The function GetMeals( ) may depend on another function Rank( ). The function Rank( ) need not be defined on the user's computer if the function is defined on another computer, such as a server computer.

The function Rank( ) may return the ten meals of a given type, e.g., breakfasts, that best match a user's preferences according to a specified merit function. For example, the merit function may be CalorieMerit( ) that may indicate which breakfast recipes most closely match the user's preferences. The asterisk in the invocation of CalorieMerit( ) may indicate that an additional argument may be specified. For example, the CalorieMerit( ) function may take a second argument representing a particular breakfast recipe, and the function Rank( ) may provide this argument.

The function GetCombination( ) may receive as input a number of breakfasts, lunches, and snacks (for example, the ones returned by GetMeals( ) and select one of each to present to the user. An example implementation of GetCombination( ) is not presented but any suitable method known to one of skill in the art may be used to implement GetCombination( ).

The application on a server computer may have a different set of expressions than those on the user's computer. For example, the server computer may have the following expressions:

server Dinners=([title=“Roast Lemon Chicken”,Calories=825, . . . ], . . . )

server Breakfasts=([title=“French Toast”,Calories=250, . . . ], . . . )

server Lunches=([title=“Grilled Cheese”,Calories=470, . . . ], . . . )

server Snacks=([title=“Bagel Chips”,Calories=125, . . . ], . . . )

server CalorieMerit(Calories,Recipe)=100−Abs(Calories,Recipe.Calories)

GetCombination(Breakfasts,Lunches,Snacks)=( . . . )

Since the server may have access to all of the available recipes, the symbol Dinners may contain a list of all available dinner recipes. Each dinner recipe may have a number of attributes such as a title, the number of calories, the amount of protein, etc. The server may similarly have symbols for breakfast, lunch, and snack recipes.

The server may also provide a definition for the CalorieMerit( ) function. For example, CalorieMerit( ) may return 100 where a recipe has the preferred number of calories and a smaller number otherwise.

When the user selects the “complete my day” link 1715 for the roast lemon chicken recipe, the expression engine on the user's computer may solve the expression consisting of the CompleteMyDay( ) function. To solve this function, the expression engine may need to solve other expressions on which the CompleteMyDay( ) function depends. In obtaining solutions for these other expressions, the expression engine may consider at run time the most efficient way to solve these other expressions.

For example, to suggest a breakfast, lunch, and snack to complete the user's day, the application may solve the function GetCombination( ) which may return a single breakfast, lunch, and snack to present to a user. Depending on the resources available on the user's computer, this expression may be solved at the user's computer or may be solved at the server.

The function GetCombination( ) may depend on the function GetMeals( ). For example, the function GetMeals( ) may be solved to provide a list of ten breakfasts, ten lunches, and ten snacks that could be suggested to complete the user's day. The GetCombination( ) function may be solved selecting one of the breakfasts, lunch, and dinners returned by GetMeals( ).

The function GetMeals( ) may need to consider a large number of recipes. Where these recipes are not present on the user's computer, it may take a long time to transfer them to the user's computer. Also, a server computer may have greater processing power and be able to process the recipes more quickly. It may thus be more efficient to solve the GetMeals( ) function at the server computer. In some embodiments, a GetMeals( ) expression may be sent from a user's computer to a server computer, solved by a server computer, and the solution sent back to the user's computer. Using the example expressions indicated above, the user's computer would then have a list of ten breakfasts, ten lunches, and ten snacks to complete the user's day.

In addition to returning the ten breakfasts, lunches, and snacks, the server could return other information or data that could be used by the user's computer. For example, the server could also return the definition of the CalorieMerit( ) so that the user's computer may evaluate this expression itself.

After the application presents a suggested breakfast, lunch, and snack to complete the user's day, the user may not like the suggestion and request an another suggestion by pressing the “Next” button 1845. Since ten breakfasts, lunches, and snacks have already been received from the server, the application may use these in suggesting a different combination.

In solving the GetCombination( ) expression, the application may chose to select another combination from the previously received ten breakfasts, lunches, and snacks. Since the data is already present on the user's computer, this expression could be solved on the user's computer or could be solved at the server. Depending on the resources available to the user's computer at the time the expression is being solved (e.g., processing power and bandwidth), the expression engine on the user's computer may solve the expression itself or send the expression to the server to be solved.

Composite View Composition

The pipeline 201 also includes an application importation mechanism 241 that is perhaps included as part of the authoring component 240. The application importation mechanism 241 provides a user interface or other assistance to the author to allow the author to import at least a portion of a pre-existing analytics-driven application into the current analytics-driven application that the user is constructing. Accordingly, the author need not always begin from scratch when authoring a new analytics application. The importation may be of an entire analytics-driven application, or perhaps a portion of the application. For instance, the importation may cause one or more or all of the following six potential effects.

As a first potential effect of the importation, additional application input data may be added to the pipeline. For instance, referring to FIG. 2, additional data might be added to the input data 211, the analytics data 221 and/or the view data 231. The additional application input data might also include additional connectors being added to the data access component 310 of FIG. 3, or perhaps different data canonicalization components 330.

As a second potential effect of the importation, there may be additional or modified bindings between the application input data and the application parameters. For instance, referring to FIG. 4, the data-application binder 410 may cause additional bindings to occur between the canonicalized data 401 and the application parameters 411. This may cause an increase in the number of known application parameters.

As a third potential effect of the importation, there may be additional application parameters to generate a supplemental set of application parameters. For instance, referring to FIG. 4, the application parameters 411 may be augmented due to the importation of the analytical behaviors of the imported application.

As a fourth potential effect of the importation, there may be additional analytical relationships (such as equations, rules and constraints) added to the application. The additional input data resulting from the first potential effect, the additional bindings resulting for the second potential effect, the additional application parameters resulting from the third potential effect, and the additional analytical relationships resulting from the fourth effect. Any one of more of these additional items may be viewed as additional data that affects the view composition. Furthermore, any one or more of these effects could change the behavior of the solver 440 of FIG. 4.

As a fifth potential effect of the importation, there may be additional or different bindings between the application parameters and the input parameters of the view. For instance, referring to FIG. 5, the application-view binding component 510 binds a potentially augmented set of application parameters 411 to a potentially augmented set of view components in the view component repository 520.

As a sixth potential effect of the importation, there may be additional parameterized view components added to the view component repository 520 of FIG. 5, resulting in perhaps new view items being added to the view composition.

Accordingly, by importing all or a portion of another application, the data associated with that application is imported. Since the view composition is data-driven, this means that the imported portions of the application are incorporated immediately into the current view composition.

When the portion of the pre-existing analytics-driven analytics application is imported, a change in data supplied to the pipeline 201 occurs, thereby causing the pipeline 201 to immediately, or in response to some other event, cause a regeneration of the view composition. Thus, upon what is essentially a copy and paste operation from an existing application, that resulting composite application might be immediately viewable on the display due to a resolve operation.

As an example of how useful this feature might be, consider the Feng Shui room view composition of FIG. 6. The author of this application may be a Feng Shui expert, and might want to just start from a standard room layout view composition model. Accordingly, by importing a pre-existing room layout model, the Feng Shui expert is now relatively quickly, if not instantly, able to see the room layout 601 show up on the display shown in FIG. 6. Not only that, but now the furniture and room item catalog that normally might come with the standard room layout view composition model, has now become available to the Feng Shui application of FIG. 6.

Now, the Feng Shui expert might want to import a basic pie chart element as a foundation for building the Feng Shui meter 602. Now, however, the Feng Shui expert might specify specific fixed input parameters for the chart element including perhaps that there are 8 wedges total, and perhaps a background image and a title for each wedge. Now the Fung Shui expert need only specify the analytical relationships specifying how the application parameters are interrelated. Specifically, the color, position, and type of furniture or other room item might have an effect on a particular Feng Shui score. The expert can simply write down those relationships, to thereby analytically interconnect the room layout 601 and the Feng Shui score. This type of collaborative ability to build on the work of others may generate a tremendous wave of creativity in creating applications that solve problems and permit visual analysis. This especially contrasts with systems that might allow a user to visually program a one-way data flow using a fixed dependency graph. Those systems can do one-way solves, the way originally programmed from input to output. The principles described herein allow solves in multiple ways, depending on what is known and what is unknown at any time given the interactive session with the user.

Visual Interaction

The view composition process has been described until this point as being a single view composition being rendered at a time. For instance, FIG. 6 illustrates a single view composition generated from a set of input data. However, the principles described herein can be extended to an example in which there is an integrated view composition that includes multiple constituent view compositions. This might be helpful in a number of different circumstances.

For example, given a single set of input data, when the solver mechanism is solving for output application variables, there might be multiple possible solutions. The constituent view compositions might each represents one of multiple possible solutions, where another constituent view composition might represented another possible solution.

In another example, a user simply might want to retain a previous view composition that was generated using a particular set of input data, and then modify the input data to try a new scenario to thereby generate a new view composition. The user might then want to retain also that second view composition, and try a third possible scenario by altering the input data once again. The user could then view the three scenarios at the same time, perhaps through a side-by-side comparison, to obtain information that might otherwise be difficult to obtain by just looking at one view composition at a time.

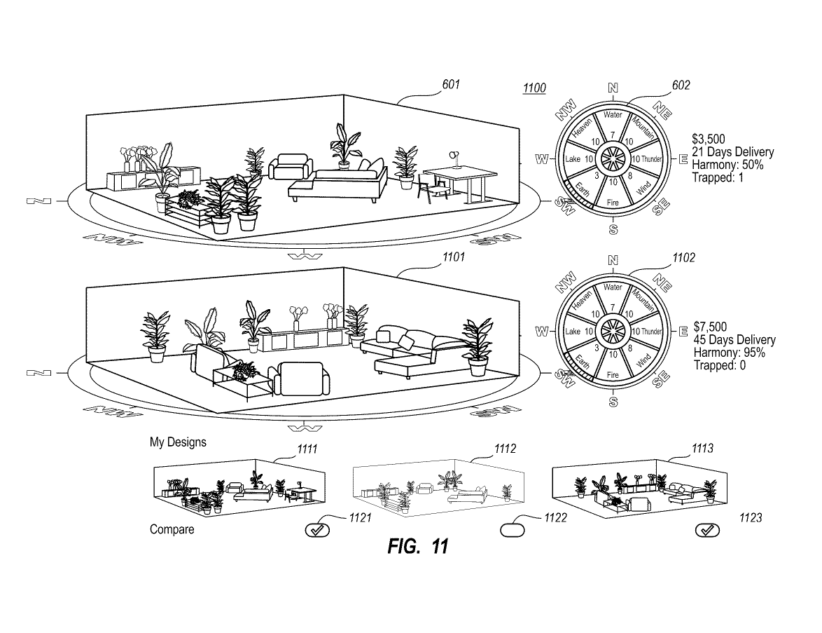

FIG. 11 illustrates an integrated view composition 1100 that extends from the Feng Shui example of FIG. 6. In the integrated view composition, the first view composition 600 of FIG. 6 is represented once again using elements 601 and 602, exactly as shown in FIG. 6. However, here, there is a second view composition that is emphasized represented. The second view composition is similar to the first view composition in the there are two elements, a room display and a Feng Shui score meter. However, the input data for the second view composition was different than the input data for the first view composition. For instance, in this case, the position data for several of the items of furniture would be different thereby causing their position in the room layout 1101 of the second view composition to be different than that of the room layout 601 of the first view composition. However, the different position of the various furniture items correlates to different Fung Shui scores in the Fung Shui meter 1102 of the second view composition as compared to the Fung Shui meter 602 of the first view composition.

The integrated view composition may also include a comparison element that visually represents a comparison of a value of at least one parameter across some of all of the previously created and presently displayed view composition. For instance, in FIG. 11, there might be a bar graph showing perhaps the cost and delivery time for each of the displayed view compositions. Such a comparison element might be an additional view component in the view component repository 520. Perhaps that comparison view element might only be rendered if there are multiple view compositions being displayed. In that case, the comparison view composition input parameters may be mapped to the application parameters for different solving iterations of the application. For instance, the comparison view composition input parameters might be mapped to the cost parameter that was generated for both of the generations of the first and second view compositions of FIG. 11, and mapped to the delivery parameter that was generated for both of the generations of the first and second view compositions.

Referring to FIG. 11, there is also a selection mechanism 1110 that allows the user to visually emphasize a selected subset of the total available previously constructed view compositions. The selection mechanism 1110 is illustrated as including three possible view constructions 1111, 1112 and 1113, that are illustrated in thumbnail form, or are illustrated in some other deemphasized manner. Each thumbnail view composition 1111 through 1113 includes a corresponding checkbox 1121 through 1123. The user might check the checkbox corresponding to any view composition that is to be visually emphasized. In this case, the checkboxes 1121 and 1123 are checked, thereby causing larger forms of the corresponding view constructions to be displayed.

The integrated view composition, or even any single view composition for that matter, may have a mechanism for a user to interact with the view composition to designate what application parameters should be treated as an unknown thereby triggering another solve by the analytical solver mechanism. For instance, in the room layout 1101 of FIG. 11, one might right click on a particular item of furniture, right click on a particular parameter (e.g., position), and a drop down menu might appear allowing the user to designate that the parameter should be treated as unknown. The user might then right click on the harmony percentage (e.g., 95% in the Fung Shui score meter 1102), whereupon a slider might appear (or a text box of other user input mechanism) that allows the user to designate a different harmony percentage. Since this would result in the identity of the known and unknown parameters being changed, a re-solve would result, and the item of furniture whose position was designated as an unknown might appear in a new location.

In one embodiment, the integrated view composition might also include a visual prompt for an adjustment that could be made that might trend a value of an application parameter in a particular direction. For example, in the Feng Shui example, if a particular harmony score is designated as a known input parameter, various positions of the furniture might be suggested for that item of furniture whose position was designated as an unknown. For instance, perhaps several arrows might emanate from the furniture suggesting a direction to move the furniture in order to obtain a higher harmony percentage, a different direction to move to maximize the water score, a different direction to move to maximum the water score, and so forth. The view component might also show shadows where the chair could be moved to increase a particular score. Thus, a user might user those visual prompts in order to improve the design around a particular parameter desired to be optimized. In another example, perhaps the user wants to reduce costs. The user might then designate the cost as an unknown to be minimized resulting in a different set of suggested furniture selections.

### Additional Example Applications

The architecture of FIGS. 1 and 2 may allow countless data-driven analytics application to be constructed, regardless of the domain. There is nothing at all the need be similar about these domains. Wherever there is a problem to be solved where it might be helpful to apply analytics to visuals, the principles described herein may be beneficial. Upon until now, only a few example applications have been described including a Feng Shui room layout application. To demonstrate the wide-ranging applicability of the principles described herein, several additional wide-ranging example applications will now be described.

### Additional Example #1

### Retailer Shelf Arrangements

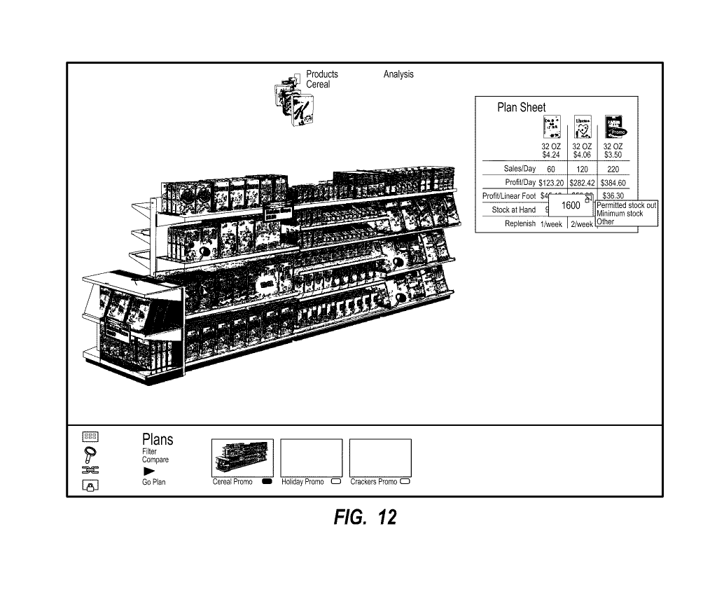

Product salespersons often use 3-D visualizations to sell retailers on shelf arrangements, end displays and new promotions. With the pipeline 201, the salesperson will be able to do what-ifs on the spot. Given some product placements and given a minimum daily sales/linear foot threshold, the salesperson may calculate and visualize the minimum required stock at hand. Conversely, given some stock at hand and given a bi-weekly replenishment cycle, the salesperson might calculate product placements that will give the desired sales/linear foot. The retailer will be able to visualize the impact, compare scenarios, and compare profits. FIG. 12 illustrates an example retailer shelf arrangement visualization. The input data might include visual images of the product, a number of the product, a linear square footage allocated for each product, and shelf number for each product, and so forth.

### Additional Example #2

### Urban Planning

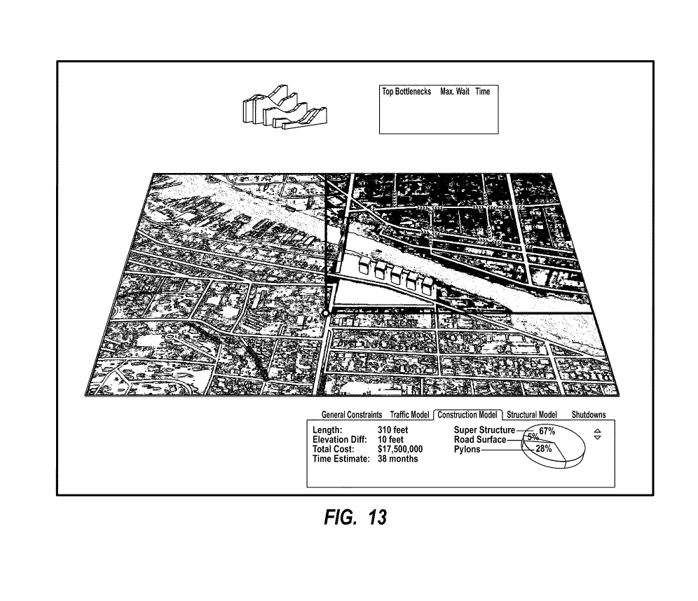

Urban planning mash ups are becoming prominent. Using the principles described herein, analytics can get integrated into such solutions. A city planner will open a traffic application created by experts, and drag a bridge in from a gallery of road improvements. The bridge will bring with it analytical behavior like length constraints and high-wind operating limits. Via appropriate visualizations, the planner will see and compare the effect on traffic of different bridge types and placements. The principles described herein may be applied to any map scenarios where the map might be for a wide variety of purposes. The map might be for understanding the features of a terrain and finding directions to some location. The map might also be a visual backdrop for comparing regionalized data. More recently, maps are being used to create virtual worlds in which buildings, interiors and arbitrary 2-D or 3-D objects can be overlaid or positioned in the map. FIG. 13 illustrates an example visualized urban plan.

### Additional Example #3

### Visual Education

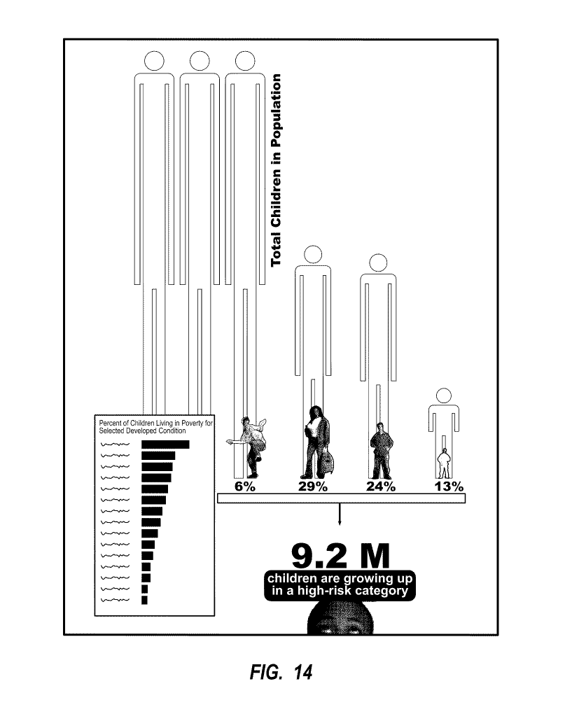

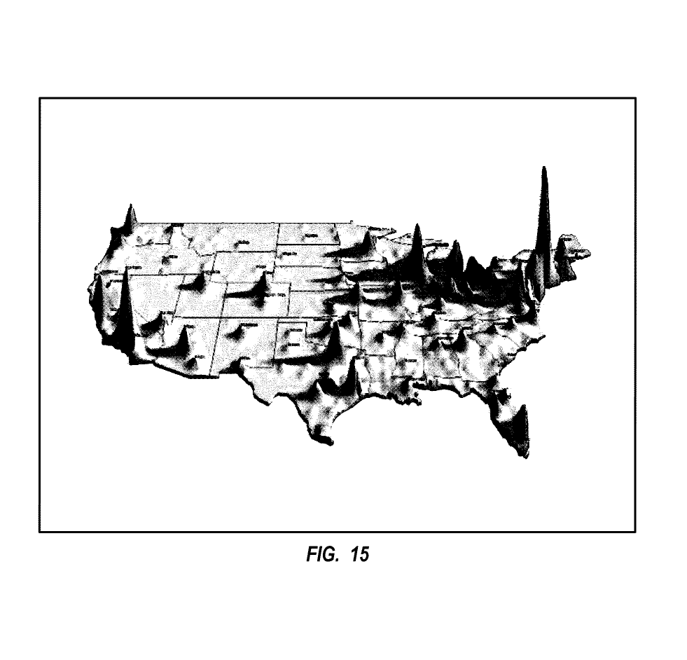

In domains like science, medicine, and demographics where complex data needs to be understood not just by domain practitioners but also the public, authors can used the principles described herein to create data visualizations that intrigue and engage the mass audience. They will use domain-specific metaphors, and impart the authors' sense of style. FIG. 14 is an illustration about children's education. FIG. 15 is a conventional illustration about population density. Conventionally, such visualizations are just static illustrations. With the principles described herein, these can become live, interactive experiences. For instance, by inputting a geographically distributed growth pattern as input data, a user might see the population peaks change. Some visualizations, where the authored application supports this, will let users do what-ifs. That is, the author may change some values and see the effect on that change on other values.

Accordingly, the principles described herein provide a major paradigm shift in the world of visualized problem solving and analysis. The paradigm shift applies across all domains as the principles described herein may apply to any domain.

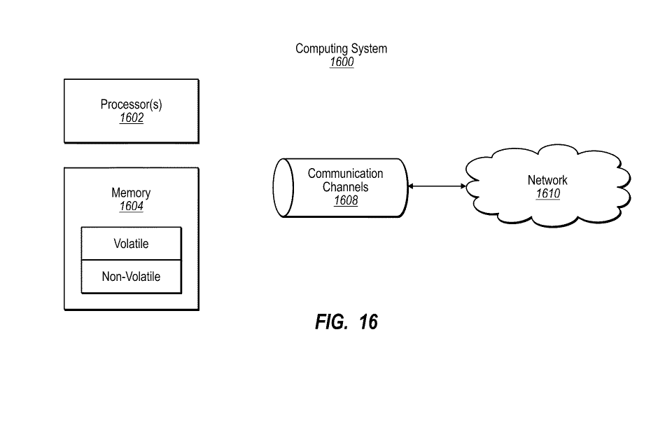

Having described the embodiments in some detail, as a side-note, the various operations and structures described herein may, but need, not be implemented by way of a computing system. Accordingly, to conclude this description, an example computing system will be described with respect to FIG. 16.

FIG. 16 illustrates a computing system 1600. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 16, in its most basic configuration, a computing system 1600 typically includes at least one processing unit 1602 and memory 1604. The memory 1604 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 1604 of the computing system 1600.

Computing system 1600 may also contain communication channels 1608 that allow the computing system 1600 to communicate with other message processors over, for example, network 1610. Communication channels 1608 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for solving a first expression at a first device, the method comprising:
selecting a second expression from an application defined by expressions, wherein the first expression depends on the second expression;
selecting a second device;
sending the second expression from the first device to the second device;
receiving at the first device a result of solving the second expression; and
using the result of solving the second expression to solve the first expression.

2. The method of claim 1, wherein the first device is one of a personal computer, a mobile phone, or a server computer.

3. The method of claim 1, wherein the second device is selected based on one of a processing power of the first device, a processing power of the second device, data available to the first device, data available to the second device, a user interface of the first device, a user interface of the second device, a speed of a network between the first device and the second device, a latency toleration for a user, or an estimation of resources needed to solve the second expression.

4. The method of claim 1, wherein at least some data is private to one of the first device or the second device.

5. The method of claim 1, wherein the first device is operating a web browser and the first expression is determined from an action of a user in the web browser.

6. The method of claim 1, wherein the second device is selected dynamically.

7. The method of claim 1, wherein the second expression is selected based on one of a processing power of the first device, a processing power of the second device, data available to the first device, data available to the second device, a user interface of the first device, a user interface of the second device, a speed of a network between the first device and the second device, a latency toleration for a user, or an estimation of resources needed to solve the second expression.

8. The method of claim 1, wherein one of a user or a service operator pays for access to the second device.

9. At least one computer-readable medium containing instructions that, when executed, perform a method for solving a first expression at a first device, wherein the first device is operating a web browser and the first expression is determined from an action of a user in the web browser, the method comprising:
selecting a second expression from an application defined by expressions, wherein the first expression depends on the second expression;
selecting a second device;
sending the second expression from the first device to the second device;
receiving at the first device a result of solving the second expression; and
using the result of solving the second expression to solve the first expression.

10. The at least one computer-readable medium of claim 9, wherein the first device is one of a personal computer or a mobile phone.

11. The at least one computer-readable medium of claim 9, wherein the second device is selected based on one of a processing power of the first device, a processing power of the second device, data available to the first device, data available to the second device, a user interface of the first device, a user interface of the second device, a speed of a network between the first device and the second device, a latency toleration for a user, or an estimation of resources needed to solve the second expression.

12. The at least one computer-readable medium of claim 9, wherein at least some data is private to one of the first device or the second device.

13. The at least one computer-readable medium of claim 9, wherein one of a user or a service operator pays for access to the second device.

14. The at least one computer-readable medium of claim 9, wherein the second device is selected dynamically.

15. The at least one computer-readable medium of claim 9, wherein the second device is a search engine.

16. A first device for solving a first expression, the first device comprising at least one processor configured to:
select a second expression from an application defined by expressions, wherein the first expression depends on the second expression;
select a second device;
send the second expression from the first device to the second device;
receive a result of solving the second expression; and
use the result of solving the second expression to solve the first expression.

17. The first device of claim 16, wherein the second device is selected based on one of a processing power of the first device, a processing power of the second device, data available to the first device, data available to the second device, a user interface of the first device, a user interface of the second device, a speed of a network between the first device and the second device, a latency toleration for a user, or an estimation of resources needed to solve the second expression.

18. The first device of claim 16, wherein the processor is further configured to operate a web browser and the first expression is determined from an action of a user in the web browser.

19. The first device of claim 16, wherein the second device is selected dynamically.

20. The first device of claim 16, wherein the second device is a search engine.
